(19) United States
(12) Patent Application Publication
(10) Pub. No.: US 2026/0204069 A1
(43) Pub. Date: Jul. 16, 2026

(54) SYSTEMS AND METHODS FOR IMPLEMENTING MACHINE LEARNING FOR VIDEO CLIPPING

(71) Applicant: STATS LLC, Chicago, IL (US)

(72) Inventors: Niall HENDRY, London (GB); Samir GOLE, Haddonfield, NJ (US); Christian MARKO, Graz (AT); Karl FERK, Graz (AT); Robert SEIDL, Munich (DE); Zsolt BIRO, Graz (AT); Madison Rose HOM, London (GB); Stephen Andrew SKWERES, Highland Park, IL (US)

(73) Assignee: STATS LLC, Chicago, IL (US)

(21) Appl. No.: 19/444,838

(22) Filed: Jan. 9, 2026

Related U.S. Application Data
(60) Provisional application No. 63/743,911, filed on Jan. 10, 2025.

(51) Int. Cl. G06V 20/40

(52) U.S. Cl. CPC G06V 20/49; G06V 20/42

(57) ABSTRACT

A method for generating video clips of a sporting occasion by implementing a machine learning model, the method including: receiving a video feed of a sporting occasion; receiving a plurality of event data objects related to the sporting occasion, each of the event data objects indicating an action in the sporting occasion and including corresponding metadata and timestamps; determining, based on the plurality of event data objects, that a trigger event occurred, the trigger event being a predefined or dynamically determined action in the sporting occasion; determining, using a machine learning model, a qualifier associated with the trigger event; and generating a video clip of the trigger event from the video of the sporting occasion, the video clip being generated based on the determined qualifier.

### CROSS-REFERENCE TO RELATED APPLICATIONS

This application claims the benefit of priority to U.S. Provisional Application Ser. No. 63/743,911, filed Jan. 10, 2025, which is hereby incorporated by reference in its entirety.

### TECHNICAL FIELD

Various embodiments of the present disclosure relate generally to generating a video clip of a sporting occasion and, more particularly, to systems and methods for implementing machine learning to perform video clipping of a sporting occasion

### INTRODUCTION

With the rising popularity of sports and the proliferation of digital media platforms, there is an increased desire for short form sports content. For example, users may desire to see highlights of individual players, sporting actions, and/or teams throughout a sporting occasion. In particular, highlights may be valuable when generated as close as possible to the live occurrence of an event during a sporting occasion. The demand for real-time or near real-time highlight content has grown as social media platforms and streaming services compete to deliver timely sports content to engaged audiences. Generating customized highlights in a short period of time after the occurrence of the event during the sporting occasion may be challenging. Existing solutions may not create customized highlight videos quickly enough for consumers during a sporting occasion. Manually creating customized highlights may be inefficient and time consuming, requiring skilled video editors and significant post-production resources. Furthermore, the volume of sporting occasions occurring simultaneously across multiple leagues and competitions makes manual highlight generation impractical for comprehensive coverage. There may exist a need for automated systems capable of intelligently identifying significant events, understanding the context surrounding those events, and generating high-quality video clips that capture the complete narrative of important sporting moments.

Unless otherwise indicated herein, the techniques and information described in this section are not prior art to the claims in this application and are not admitted to be prior art, or suggestions of the prior art, by inclusion in this section.

### SUMMARY OF THE DISCLOSURE

In some aspects, the techniques described herein relate to a method for generating video clips of a sporting occasion by implementing a machine learning model, the method comprising: receiving a video feed of a sporting occasion; receiving a plurality of event data objects related to the sporting occasion, each of the event data objects indicating an action in the sporting occasion and including corresponding metadata and timestamps; determining, based on the plurality of event data objects, that a trigger event occurred, the trigger event being a predefined or dynamically determined action in the sporting occasion; determining, using a machine learning model, a qualifier associated with the trigger event; determining, based on the qualifier, clipping parameters for a video clip, wherein the clipping parameters define a time interval relative to the trigger event; and generating the video clip of the trigger event from the video feed of the sporting occasion, the video clip being generated based on the clipping parameters.

In some aspects, the techniques described herein relate to a method further comprising overlaying graphical content on the video clip, wherein the graphical content includes one or more of augmented graphics displaying player positioning information, statistical data associated with the trigger event, expected goal (xG) values, expected pass values, expected threat values, distance measurements between players, or data-driven visual elements.

In some aspects, the techniques described herein relate to a method further comprising: receiving tracking data of the sporting occasion from a tracking system; determining, based on the tracking data, a cropping format for the video clip; and automatically cropping the video clip to the determined cropping format by identifying a location of an object or player in the video feed based on the tracking data and dynamically adjusting a display area to follow the object or player.

In some aspects, the techniques described herein relate to a method further comprising: identifying a related event associated with the trigger event, wherein the related event includes one or more of: a replay of the trigger event from a different camera perspective, a video review decision related to the trigger event, or a subsequent action following the trigger event; generating a second video clip of the related event; and chaining together the video clip of the trigger event and the second video clip of the related event to create a combined video clip, wherein the combined video clip is automatically generated without creating an intermediate raw clip.

In some aspects, the techniques described herein relate to a method wherein the plurality of event data objects include pre-defined or automatically generated actions that occur during the sporting occasion.

In some aspects, the techniques described herein relate to a method wherein the metadata for each respective event data object includes: classification metrics defining the respective event data object, and players associated with the respective event data object.

In some aspects, the techniques described herein relate to a method wherein determining the qualifier includes: processing, using the machine learning model, a portion of the plurality of event data objects with timestamps prior to the trigger event, and identifying a pattern of play leading to the trigger event, wherein the pattern of play includes a sequence of actions performed by one or more players.

In some aspects, the techniques described herein relate to a method wherein the video clip includes video clip metadata, the video clip metadata includes one or more of a player associated with the trigger event, a team associated with the trigger event, a date associated with the sporting occasion, or a timestamp associated with the trigger event.

In some aspects, the techniques described herein relate to a method wherein the video clip is generated by a second machine learning model, the second machine learning model being configured to fuse multiple views of the trigger event into the video clip.

In some aspects, the techniques described herein relate to a method wherein determining the clipping parameters includes: accessing a lookup table or database that associates the determined qualifier with corresponding clipping rules; retrieving, from the lookup table or database, a time interval associated with the determined qualifier, wherein the time interval defines a duration prior to the trigger event to be included in the video clip; determining a start point for the video clip based on the time interval and a timestamp of the trigger event; and generating a refined start point using a second machine learning model configured to identify one or more of: an audio break point in audio associated with the video feed, or a scene cut in the video feed, wherein the refined start point corresponds to a natural break point proximate to the start point.

In some aspects, the techniques described herein relate to a system for generating video clips of a sporting occasion by implementing a machine learning model, the system comprising: a non-transitory computer readable medium configured to store processor-readable instructions; and a processor operatively connected to the non-transitory computer readable medium, and configured to execute the instructions to perform operations comprising: receiving a video feed of a sporting occasion; receiving a plurality of event data objects related to the sporting occasion, each of the event data objects indicating an action in the sporting occasion and including corresponding metadata and timestamps; determining, based on the plurality of event data objects, that a trigger event occurred, the trigger event being a predefined or dynamically determined action in the sporting occasion; determining, using a machine learning model, a qualifier associated with the trigger event; determining, based on the qualifier, clipping parameters for a video clip, wherein the clipping parameters define a time interval relative to the trigger event; and generating the video clip of the trigger event from the video feed of the sporting occasion, the video clip being generated based on the clipping parameters.

In some aspects, the techniques described herein relate to a system wherein the operations further comprise: overlaying graphical content on the video clip, wherein the graphical content includes one or more of augmented graphics displaying player positioning information, statistical data associated with the trigger event, expected goal (xG) values, expected pass values, expected threat values, distance measurements between players, or data-driven visual elements.

In some aspects, the techniques described herein relate to a system wherein the operations further comprise: receiving tracking data of the sporting occasion from a tracking system; determining, based on the tracking data, a cropping format for the video clip; and automatically cropping the video clip to the determined cropping format by identifying a location of an object or player in the video feed based on the tracking data and dynamically adjusting a display area to follow the object or player.

In some aspects, the techniques described herein relate to a system wherein the operations further comprise: identifying a related event associated with the trigger event, wherein the related event includes one or more of: a replay of the trigger event from a different camera perspective, a video review decision related to the trigger event, or a subsequent action following the trigger event; generating a second video clip of the related event; and chaining together the video clip of the trigger event and the second video clip of the related event to create a combined video clip, wherein the combined video clip is automatically generated without creating an intermediate raw clip.

In some aspects, the techniques described herein relate to a non-transitory computer readable medium storing processor-readable instructions which, when executed by at least one processor, cause the at least one processor to perform operations including: receiving a video feed of a sporting occasion; receiving a plurality of event data objects related to the sporting occasion, each of the event data objects indicating an action in the sporting occasion and including corresponding metadata and timestamps; determining, based on the plurality of event data objects, that a trigger event occurred, the trigger event being a predefined or dynamically determined action in the sporting occasion; determining, using a machine learning model, a qualifier associated with the trigger event; determining, based on the qualifier, clipping parameters for a video clip, wherein the clipping parameters define a time interval relative to the trigger event; and generating the video clip of the trigger event from the video feed of the sporting occasion, the video clip being generated based on the clipping parameters.

In some aspects, the techniques described herein relate to a non-transitory computer readable medium wherein the operations further include: overlaying graphical content on the video clip, wherein the graphical content includes one or more of augmented graphics displaying player positioning information, statistical data associated with the trigger event, expected goal (xG) values, expected pass values, expected threat values, distance measurements between players, or data-driven visual elements.

In some aspects, the techniques described herein relate to a non-transitory computer readable medium wherein the operations further include: receiving tracking data of the sporting occasion from a tracking system; determining, based on the tracking data, a cropping format for the video clip; and automatically cropping the video clip to the determined cropping format by identifying a location of an object or player in the video feed based on the tracking data and dynamically adjusting a display area to follow the object or player.

In some aspects, the techniques described herein relate to a non-transitory computer readable medium wherein the operations further include: generating a plurality of additional video clips for a plurality of additional trigger events occurring during the sporting occasion; assigning a rating score to each additional video clip of the plurality of additional video clips, wherein the rating score is determined based on characteristics of a corresponding trigger event from the plurality of additional trigger events, and wherein the rating score rates each additional trigger event relative to other additional trigger events of a same type; selecting a subset of the plurality of additional video clips based on the assigned rating scores; and generating a highlight package by combining the subset of the plurality of additional video clips and the video clip.

It is to be understood that both the foregoing general description and the following detailed description are example and explanatory only and are not restrictive of the detailed embodiments, as claimed.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram of a video clipping environment, according to one or more embodiments.

FIG. 3 is a flow diagram of an exemplary method for implementing a machine learning model to generate a video clip, according to one or more embodiments.

FIG. 4 is an exemplary user interface for a client system to select video clipping outputs, according to one or more embodiments.

FIG. 5 is a flow diagram of an exemplary method for generating video clips of sporting occasions, according to one or more embodiments.

FIG. 6 depicts a user interface for selecting video generation settings, according to one or more embodiments.

FIG. 7A is a flow diagram of an exemplary method for generating video clips from a query, according to one or more embodiments.

FIG. 7B is a flow diagram of an exemplary method for generating a video highlight package based on user history, according to one or more embodiments.

FIG. 8 is a snapshot of a generated video clip, according to one or more embodiments.

FIG. 9A is a flow diagram of an exemplary method for generating a highlight package, according to one or more embodiments.

FIG. 9B is a flow diagram of an exemplary method for generating a highlight package based on user selections, according to one or more embodiments.

FIG. 10 is a flow diagram of an exemplary method for generating a chained video clip, according to one or more embodiments.

FIG. 11 depicts a flow diagram of a method for generating video clips of a sporting occasion by implementing a machine learning model, according to one or more embodiments.

FIG. 12 depicts a flow diagram for training a machine-learning model, according to example embodiments.

FIG. 13A is a block diagram illustrating a computing device, according to example embodiments.

FIG. 13B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various embodiments of the present disclosure relate generally to generating video clips of a sporting occasion and, more particularly, to systems and methods for implementing machine learning to perform video clipping of sporting occasions.

According to embodiments disclosed herein, a system may receive, as an input, a video of a sporting occasion along with associated event data objects which define actions of the sporting occasion. The system described herein may analyze the received event data objects to automatically determine when a trigger event occurs. A trigger event may be an action in the sporting occasion based on which the system may generate a video clip. Upon the determination of a trigger event occurring, the system may further qualify (e.g., define) the trigger event by determining one or more associated qualifiers. The system may determine the qualifier(s) and associated clipping parameters by implementing a machine learning model. An exemplary trigger event may be a player scoring a goal during a soccer sporting occasion. Potential qualifiers that may be determined for the goal may include, but are not limited to, a category of action (e.g., a direct free-kick goal, a set-piece goal, a fast break goal, a goal resulting from a throw in, a goal resulting from a corner, a direct-corner goal, a penalty based goal, etc.), actors associated with the action (e.g., players, teams, etc.), rankings associated with the action, duration of the action, or the like. The system may then generate a video clip of the trigger event based on the determined qualifier. This video clip may be saved to a video repository and/or output to one or more client servers. The system advantageously may provide real-time or near real-time video clip generation, enabling immediate distribution of highlights during live sporting occasions, which is particularly valuable for social media platforms, broadcasting networks, and sports organizations seeking to engage audiences with timely content.

Various embodiments described herein may relate to generating video clips of a sporting occasion. A sporting occasion may refer to any organized athletic competition, match, game, or event in which one or more participants engage in physical activity governed by established rules. Sporting occasions may include team-based competitions such as soccer matches, basketball games, and American football games, as well as individual competitions such as tennis matches, golf tournaments, and track and field events.

Traditionally, video clips displaying highlights of a sporting occasion may be created by a human manually selecting clips recorded from a recorded video. Selecting videos by hand may be time consuming and labor-intensive, often requiring skilled video editors and significant post-production resources. Further, highlights may take longer to be created and may not be immediately available for consumer distribution. This delay in content availability may result in missed opportunities for audience engagement, particularly in today's fast-paced digital media environment where consumers expect immediate access to highlight content. Additionally, manual video editing processes may be prone to human error and inconsistency, leading to variations in video quality and content selection that may not align with viewer preferences or optimal engagement metrics.

Further, traditional systems that implement an automated creation of a video may be simple and rule based (e.g., based on a predetermined or non-dynamic clipping time). These rule-based systems may miss important aspects of a particular event and lack the contextual understanding necessary to create compelling highlight content. For example, if an automatic video generator has a rule to include 10 seconds before and after a goal in a soccer match, there may be scenarios where critical aspects that lead up to the goal may be missed such as a fast break that began 15 seconds before a goal. Alternatively, there may be scenarios where the 10 seconds before and/or after the particular event may capture video content not related or highly relevant to the particular event. Such rigid rule-based approaches may fail to account for the dynamic nature of sporting occasions and the varying contexts that may make certain moments more or less significant. Moreover, these systems may not be able to adapt to different sports, playing styles, or evolving viewer preferences, resulting in generic content that lacks the nuanced understanding required for optimal highlight creation.

The system described herein may be configured to receive a video feed of a sporting occasion and to generate a video clip of a trigger event automatically upon the occurrence of the trigger event. A trigger event may be defined as a predefined or dynamically determined event/action within a sporting occasion. A trigger event may be an event for which a user has requested a video clip (e.g., a highlight). Alternatively, a trigger event may be an event that is automatically identified as an event to be captured in a highlight (e.g., based on a type of event, a ranking of the event, etc.). For example, in a soccer sporting occasion, exemplary trigger events may include, but are not limited to, a goal, a yellow card, a red card, a shot on goal, a big chance, a clearance, a block, a penalty, a free-kick, a corner, an interception, a foul, a pass, or a tackle. The system described herein may be applied to generate video clips for all sporting occasions, including, but not limited to soccer, basketball, American football, rugby, cricket, tennis, team sports, individual sports, and/or the like. The system's versatility extends to various competition levels, from professional leagues to amateur tournaments, and maybe customized to accommodate different broadcasting standards, regional preferences, and platform-specific requirements.

The system described herein may further determine a qualifier associated with a respective trigger event. The system may incorporate the qualifier to more accurately generate a video clip. A given trigger event may be associated with a set of qualifiers that categorize the trigger event as a type of that trigger event. Accordingly, a qualifier may classify a trigger event as being a given category of that trigger event, from a set of categories with respective qualifiers. For example, a qualifier may further define a respective trigger event and define the pattern of play leading to or otherwise associated with a trigger event (e.g., the context associated with a trigger event). An exemplary qualifier for a goal in a soccer sporting occasion may include open play (e.g., where six or more passes occurred prior to the goal), a direct free kick, a set piece, a fast break, a throw in, a corner, a direct corner, a penalty, a set piece, or the like. As will be described in greater detail below, a qualifier for a trigger event may be determined by the system by using a machine learning model to analyze event data objects prior to the trigger event. This intelligent qualification system may allow for the creation of contextually appropriate video clips that capture the full narrative of significant sporting moments, rather than arbitrary time-based segments.

Advantageously, the system described herein may consider the described qualifiers when automatically generating a video clip based on a trigger event. By considering the events that occur leading up to or that are otherwise associated with a trigger event, the machine learning model may learn what actions or content to incorporate within the generated video clip in addition to video content of a trigger event. This contextual awareness may ensure that generated video clips tell a complete story, capturing the tactical buildup, key player movements, and strategic elements that contribute to the significance of the trigger event. The system's ability to understand and incorporate context may result in more engaging and informative highlight content that provides viewers with a comprehensive understanding of how significant moments develop during sporting occasions.

Advantageously, the system described herein may generate video clips of trigger events within seconds or minutes of the trigger event occurring within the received video speed (e.g., in real-time). These highlights may be generated faster than previous systems and may allow for generating highlights (e.g., a video clip) shortly after the occurrence of a trigger event, without human involvement. This rapid generation capability may enable real-time content distribution across multiple platforms simultaneously, supporting live social media engagement, instant replay systems, and immediate broadcast integration. The speed of generation may allow for the creation of multiple versions of the same highlight in different formats, resolutions, and durations to meet diverse distribution requirements without additional processing delays.

Further, as will be discussed in greater detail below, a video repository may store each generated video clip. The video repository may include metadata associated with each generated video clip. The video clip metadata may include one or more players associated with the trigger event, one or more teams associated with the trigger event, a date associated with the sporting occasion, a timestamp associated with the trigger event, properties of the trigger event, qualifiers associated with the trigger event, and/or further defining details of the trigger event. This stored metadata may allow for one or more users to search for generated clips or to generate clips based on associated metadata (e.g. a user may search for videos of Ronaldo's goals during the 2023 season). The comprehensive metadata system may also enable advanced analytics, content recommendation algorithms, and automated compilation of player-specific or team-specific highlight packages, facilitating both immediate content discovery and long-term content management strategies.

The system described herein may be configured to allow a user or automated feature to generate rules for creating video clips. For example, a user or automated feature may input what trigger events to generate video clips for. The user or automated feature may further include other clipping parameters such as competition (e.g., what league or teams to generate clips for), what resolution of video, what video size (e.g., aspect ratio), whether to include an uploaded logo, and/or any pre-roll/post-roll video clips to include. Such utilization of other clipping parameters may allow for the system described herein to be customizable for particular needs. For example, according to an embodiment, a video clip generated based on a trigger event may automatically be updated to include pre-roll/post-roll video clips, a logo, and may be adjusted to have a given resolution based on user or automated inputs. The system's flexibility may extend to supporting multiple output formats simultaneously, enabling organizations to maintain consistent branding across different distribution channels while optimizing content for platform-specific requirements such as social media aspect ratios, broadcast standards, or mobile viewing preferences.

In some examples, the system described herein may incorporate a machine learning model to generate the video clip. For example, the machine learning model may be utilized to fuse multiple views of a trigger event and preceding and/or post events in the sporting occasion. This machine learning model may be responsible for zooming in on footage and cropping footage to focus on key aspects of a trigger event. The intelligent video processing capabilities may include automatic camera angle selection, dynamic framing adjustments, and seamless transitions between different perspectives to create professional-quality highlight content. Additionally, the machine learning model may identify and track key players, objects, and areas of interest throughout the video sequence, ensuring that the most relevant visual elements remain in focus and properly framed throughout the generated clip.

In some examples, the system described herein may further be configured to incorporate granular data as overlays on a particular generated video clip. For example, artificial intelligence (AI) created insight (e.g., the predicted chance of a goal being a goal, based on the players shot), may be overlaid on the generated video. For example, a video may be created of a goal scored by a particular player (e.g., Lionel Messi), which includes metadata indicating the shot location inside the box and with his left foot. Further, an xG metric, defined as the percentage (on a scale of 0 to 1), that a particular shot is a goal may be overlaid on the generated video prior to and during the goal. These data overlays may include additional performance metrics such as player speed, distance covered, pass accuracy, defensive pressure indicators, and tactical formation visualizations, providing viewers with enhanced analytical insights that complement the visual content and create more engaging, educational highlight experiences.

In some examples, the system may be implemented as an automated tool to clip and enhance a video from within a broadcast, allowing for one or more automated systems to perform editing tasks, adding effects, and branding to develop raw footage into polished branded video clips. The system may allow for a user or automated feature to customize functions for creation of rules to generate particular video clips via an automated system. A rule may be defined as a list of functions that will customize the edit list to a raw clip. The rule may convert a raw clip into a branded clip to add value to the raw clip. This rule may be sourced to edit and customize each raw clip into a branded clip. Each individual rule may be assigned to the matches within a competition. As matches are broadcast live, raw clips of the key events may automatically be converted to branded clips in near-real time (e.g., within approximately 5 minutes). A user may be able to access additional editing functions and/or provide guidance for an automated system to perform editing such as modifying queue in/queue out (e.g., prioritizing which videos are generated first, and the order of videos within a package of video clips). A user may be able to select when to swap audio tracks on generated video clips. The system's scalability may allow the system to process multiple concurrent sporting occasions, manage high-volume content generation during peak sporting seasons, and maintain consistent quality standards across diverse content types while supporting enterprise-level deployment requirements for large-scale sports media operations.

In some embodiments, the techniques described herein may be applied to generate video clips of live events other than sporting occasions. For example, the system may be configured to process video feeds and event data objects from award shows, concerts, political debates, live theater performances, news broadcasts, or other televised or streamed events. The underlying architecture for receiving video feeds, analyzing event data objects, determining trigger events, identifying qualifiers, generating video clips based on clipping parameters, and/or any other techniques and systems described herein may be adapted to accommodate the characteristics and conventions of various live event types.

In the context of an award show, for example, an event data object may indicate an action such as an award presentation, a musical performance, a speech, or an audience reaction. A trigger event may be defined as an award announcement or a notable moment during an acceptance speech. A qualifier associated with the trigger event may categorize the award announcement based on the award category, the recipient, or characteristics of the acceptance speech such as duration or emotional content. The clipping parameters may define a time interval that captures the lead-up to the award announcement, the moment of revelation, and a portion of the recipient's reaction or speech. In this manner, the system may automatically generate video clips of significant moments from live events across various entertainment and media contexts.

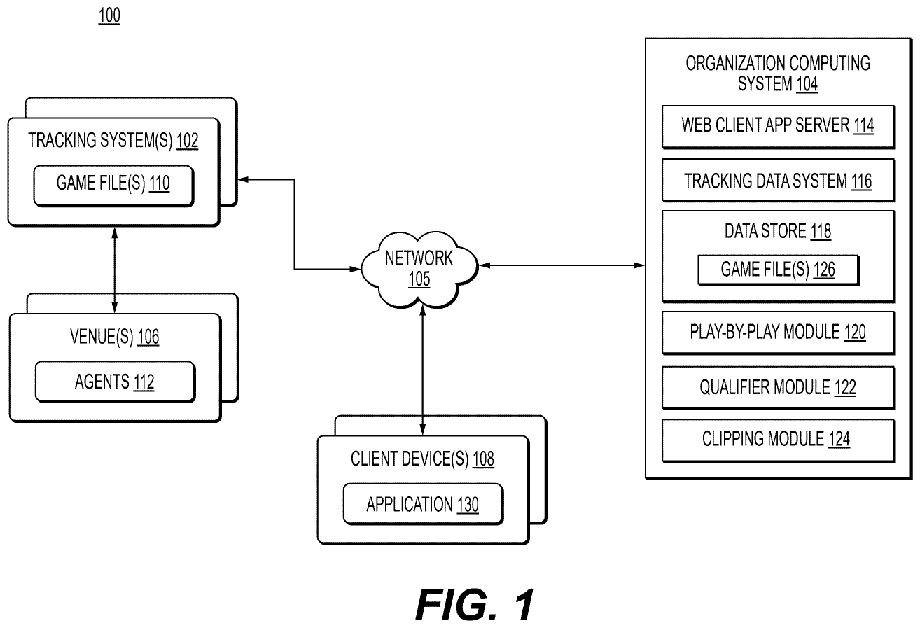

FIG. 1 is a block diagram illustrating a computing environment 100, according to example embodiments. The computing environment 100 may include a tracking system 102 (e.g., positioned at or in communication with one or more components positioned at a venue 106), an organization computing system 104, and one or more client devices 108 communicating via a network 105.

The network 105 may be of any suitable type, including individual connections via the Internet, such as cellular or Wi-Fi networks. In some embodiments, the network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connections to be encrypted or otherwise secured. In some embodiments, however, the information being transmitted may be less personal, and therefore, the network connections may be selected for convenience over security.

The network 105 may include any type of computer networking arrangement used to exchange data or information. For example, the network 105 may be the Internet, a private data network, virtual private network using a public network and/or other suitable connection(s) that enables components in the computing environment 100 to send and receive information between the components of the computing environment 100.

The tracking system 102 may be positioned in the venue 106 and/or may be in communication (e.g., electronic communication, wireless communication, wired communication, etc.) with the venue 106 and/or components thereof. For example, the venue 106 may be configured to host a sporting occasion that includes one or more agents 112. The tracking system 102 may be configured to capture the motions of one or more agents (e.g., players) on the playing surface, as well as one or more other agents (e.g., objects) of relevance (e.g., ball, puck, referees, etc.). In some embodiments, the tracking system 102 may be an optically based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system (e.g., the tracking system 102) may result in many different camera views of the playing surface (e.g., high sideline view, free-throw line view, huddle view, face-off view, end zone view, etc.).

In some embodiments, the tracking system 102 may be used for a broadcast feed of a given sporting occasion. For example, the tracking system 102 may be used to generate first occasion files 110 to facilitate a broadcast feed of a given match. In such embodiments, each frame of the broadcast feed may be stored in the first occasion file 110. A broadcast feed may be a feed that is formatted to be broadcast over one or more channels (e.g., broadcast channels, internet-based channels, etc.). The first occasion file 110 may be converted from a first format (e.g., a format output by the one or more cameras or a different format than the format output by the one or more cameras) and may be converted into a second format (e.g., for broadcast transmission).

As an example, tracking data may include the positions (e.g., x=(x, y)) of each entity (or player) at each time step on a playing surface. Tracking data may be generated and/or stored in a format different than the format of an occasion file or broadcast transmission. For example, a broadcast transmission may include video files, whereas tracking data may be generated or stored as digital representations of agents and/or objects in a format different than the format of the broadcast transmission (e.g., different than a video file format). In some embodiments, to represent the tracking data in a well-defined structure that avoids issues presented in conventional approaches, a pre-processing agent may construct a graphical representation of the tracking data. For example, a pre-processing agent may construct a graph G(V,E,U) that may be defined by nodes V, edges E, and global features U. In some embodiments, each node in a graph may represent the player and ball tracking data. In some embodiments, each edge may include information about various relationships between nodes. In some embodiments, edges eij may be directed edges and connect a sending node vi to a receiving node vj.

In some embodiments, the first occasion file 110 may further be augmented with other event information corresponding to event data objects, such as, but not limited to, event information (pass, made shot, turnover, etc.) and context information (current score, time remaining, etc.). Event data objects may be automatically identified using a machine learning trained to receive, as an input, the first occasion file 110 or a subset thereof and output occasion information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include occasion files or simulated occasion files from historical occasions, simulated occasions, and/or the like and may include tagged and/or untagged data.

According to embodiments disclosed herein, event data may be generated based on tracking data and/or content feeds (e.g., in-venue video feeds, broadcast feeds, etc.). For example, tracking data may be generated by providing a content feed to one or more machine learning models. The one or more machine learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a prediction module to make predictions. The tracking data may be analyzed by the machine learning models to determine correlations between the tracking data and event types (e.g., goal scored, pass made, play types, etc.). For example, tracking data may be used to determine when a digital representation of an object (e.g., a ball) crosses a scoring object (e.g., a goal post). The determination may be based on, for example, detection of a triggering change between a first tracking data digital representation and a second tracking data digital representation, where the triggering change may be for a given event type. More specifically, the determination may be made based on a component or machine learning algorithm detecting the triggering change between the first tracking data digital representation and the second tracking data digital representation, and automatically identifying correlations between the triggering change and attributes associated with one or more event types. If a correlation meets a correlation threshold for a given event type, the triggering change may be associated with the given event type, and may be tagged as event data for that event type. Such automated event data detection may be performed, for example, by a machine learning model using input data (e.g., tracking data and/or occasion files) that are in a non-human readable format optimized for machine learning operations. Based on such determination, for example, an event type of a goal scored may be identified based on the digital tracking data. Further, the digital representation of the player(s) that contacted the object (e.g., ball) prior to the goal scored event may be identified as the player(s) that contributed to or otherwise caused the event (e.g., goal). Accordingly, content feeds may be used to generate tracking data which may further be used to determine event data corresponding to certain sports occasions.

The tracking system 102 may be configured to communicate with the organization computing system 104 via the network 105. For example, the tracking system 102 may be configured to provide the organization computing system 104 with a broadcast stream of a game, an occasion or event in real-time or near real-time via the network 105. As an example, the tracking system 102 may provide one or more first occasion files 110 in a first format (e.g., corresponding to a format based on the components of the tracking system 102). Alternatively, or in addition, the tracking system 102 or the organization computing system 104 may convert the broadcast stream (e.g., the first occasion files 110) into a second format, from the first format. The second format may be based on the organization computing system 104. For example, the second format may be a format associated with a data store 118, discussed further herein.

The organization computing system 104 may be configured to process the broadcast stream of the sporting occasion (e.g., a game, a match, etc.). The organization computing system 104 may include a web client application server 114, a tracking data system 116, the data store 118, a play-by-play module 120, a qualifier module 122, and/or a clipping module 124. Each of the tracking data system 116, the play-by-play module 120, the qualifier module 122, and the clipping module 124 may be comprised of one or more software modules. The one or more software modules may be collections of code or instructions stored on a media (e.g., memory of the organization computing system 104) that represent a series of machine instructions (e.g., program code) that implement one or more algorithmic steps. Such machine instructions may be the actual computer code the processor of the organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

The tracking data system 116 may be configured to receive broadcast video data and/or broadcast video feeds from the tracking system 102 and generate tracking data from the broadcast data. In some embodiments, the tracking data system 116 may apply an artificial intelligence and/or computer vision system configured to derive player-tracking data from broadcast video feeds.

To generate the tracking data from the broadcast data, the tracking data system 116 may, for example, map pixels corresponding to each player and ball to dots and may transform the dots to a semantically meaningful event layer, which may be used to describe player attributes. For example, the tracking data system 116 may be configured to ingest broadcast video received from the tracking system 102. In some embodiments, the tracking data system 116 may further categorize each frame of the broadcast video into trackable and non-trackable clips. In some embodiments, the tracking data system 116 may further calibrate the moving camera based on the trackable and non-trackable clips. In some embodiments, the tracking data system 116 may further detect players within each frame using skeleton tracking. In some embodiments, the tracking data system 116 may further track and re-identify players over time. For example, the tracking data system 116 may reidentify players who are not within a line of sight of a camera during a given frame. In some embodiments, the tracking data system 116 may further detect and track an object across a plurality of frames. In some embodiments, the tracking data system 116 may further utilize optical character recognition techniques. For example, the tracking data system 116 may utilize optical character recognition techniques to extract score information and time remaining information from a digital scoreboard of each frame.

Such techniques assist in the tracking data system 116 generating tracking data from the broadcast feed (e.g., broadcast video data). For example, the tracking data system 116 may perform such processes to generate tracking data across thousands of possessions and/or broadcast frames. In addition to such process, the organization computing system 104 may go beyond the generation of tracking data from broadcast video data. Instead, to provide descriptive analytics, as well as a useful feature representation for the clipping module 124, the organization computing system 104 may be configured to map the tracking data to a semantic layer (e.g., events).

The tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include occasion files or simulated occasion files from historical occasions, simulated occasions, historical or simulated feature representations, and/or the like and may include tagged and/or untagged data. The tagged data may include position information, movement information, object information, trends, agent identifiers, agent re-identifiers, etc.

The play-by-play module 120 may be configured to receive play-by-play data from one or more third party systems. For example, the play-by-play module 120 may receive a play-by-play feed corresponding to the broadcast video data. In some embodiments, the play-by-play data may be representative of human generated data based on events occurring within the sporting occasion (i.e., game). Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, the play-by-play module 120 may utilize machine learning outputs and/or manually annotated data that may reflect the referee's ultimate adjudication. Such data may be referred to as the play-by-play feed.

To help identify events within the generated tracking data, the tracking data system 116 may merge or align the play-by-play data with the raw generated tracking data (which may include the sporting occasion and time fields). The tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, the tracking data system 116 may be configured to perform various operations on the aligned tracking system. For example, the tracking data system 116 may use the play-by-play data to refine the player and ball positions and precise frame of the end of possession events (e.g., shot/rebound location). In some embodiments, the tracking data system 116 may further be configured to detect events, automatically, from the tracking data. In some embodiments, the tracking data system 116 may further be configured to enhance the events with contextual information.

For automatic event detection, the tracking data system 116 may include a neural network system trained to detect/refine various events in a sequential manner. For example, the tracking data system 116 may include an actor-action attention neural network system to detect/refine one or more of: shots, scores, points, rebounds, passes, dribbles, penalties, fouls, and/or possessions. The tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, the tracking data system 116 may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, the tracking data system 116 may use a measure referred to as an “influence score.” The influence score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

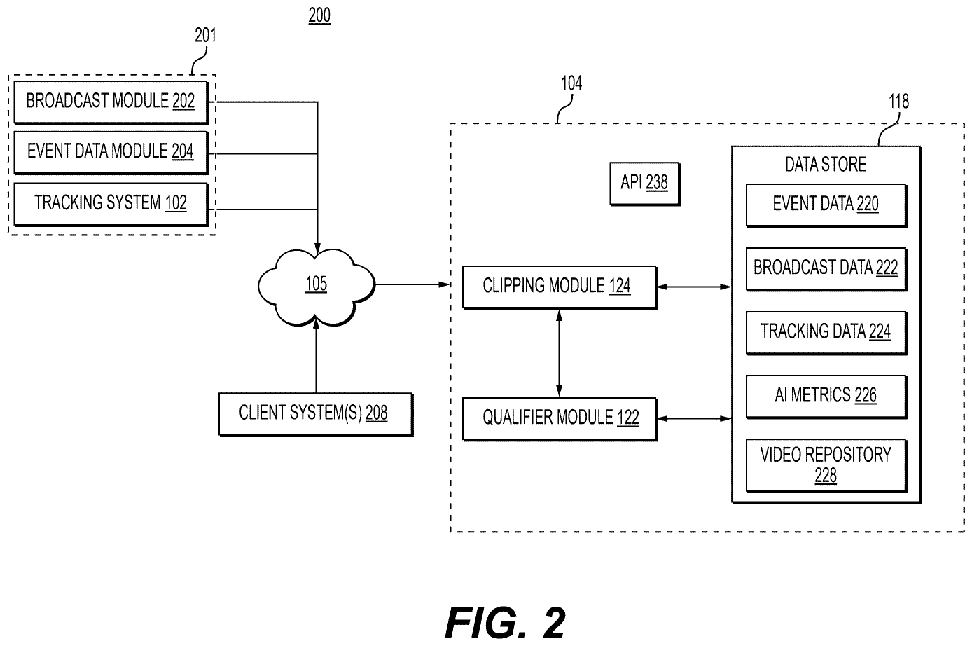

The computing environment 100 may further include the qualifier module 122. The qualifier module 122 may be configured to receive data (e.g., a data intake 201 discussed in FIG. 2 below) to determine that a trigger event has occurred. The qualifier module 122 may further include one or more machine leaning models configured to determine a qualifier associated with the trigger event. For example, machine learning models incorporated by the qualifier module may include regression models, neural networks, xG Boost models, large language models, and/or qualifier models. According to embodiments, such a qualifier module may use supervised learning to train a respective model. The qualifier module 122 may be configured to determine clipping parameters for particular trigger events and corresponding qualifiers. The clipping parameters may define the period of time prior to and after a trigger event occurring that should be included in a generated video clip.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data (e.g., experiential data and/or samples of input data) which are fed into the model in order to establish, tune, or modify one or more aspects of the model (e.g., the weights, biases, criteria for forming classifications or clusters, etc.). Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data (e.g., as ground truth). Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used (e.g., stochastic, gradient boosted, random seeded, recursive, epoch or batch-based, etc.).

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

The computing environment 100 may include the clipping module 124. The clipping module 124 may be configured to generate video clips from a video feed of a sporting occasion. The clipping module 124 may incorporate user selected rules such as aspect ratio, video format, resolution, etc. The clipping module 124 may be configured to store associated metadata with the generated video and store the generated video and metadata in a video repository (e.g., a video repository 228 as depicted in FIG. 2). The clipping module 124 may be configured to combine multiple generated video clips into a single package for user consumption.

Accordingly, the qualifier module 122 and the clipping module 124 may work in conjunction to generate video clips of trigger events. These components are described in further detail below in FIG. 2.

The data store 118 may be configured to store one or more second occasion files 126. Each second occasion file 126 may include video data of a given match. For example, the video data may correspond to a plurality of video frames captured by the tracking system 102, the tracking data derived from the broadcast video as generated by the tracking data system 116, play-by-play data, enriched data, and/or padded training data. The second occasion files 126 may be based, for example, on the first occasion files 110 as discussed herein. The second occasion files 126 may be in a different format than the first occasion files 110. For example, a first format of the first occasion files 110 or a subset thereof may be transformed into a second format of the second occasion files 126. The transformation may be performed automatically based on the type and/or content of the first format and the type and/or content of the second format. As described in greater detail below, the data store 118 may further be configured to store clipping parameters and generated video clips in a video repository.

The client device(s) 108 may be in communication with the organization computing system 104 via the network 105. The client device(s) 108 may be operated by a user or system component(s). For example, the client device(s) 108 may be a mobile device, a tablet, a desktop computer, or any computing system having the capabilities described herein. Users may include, but are not limited to, individuals such as, for example, subscribers, clients, prospective clients, or customers of an entity associated with the organization computing system 104, such as individuals who have obtained, will obtain, or may obtain a product, service, or consultation from an entity associated with the organization computing system 104.

The client device 108 may include an application 130. The application 130 may be representative of a web browser that allows access to a website or a stand-alone application. The client device 108 may access the application 130 to access one or more functionalities of the organization computing system 104. The client device 108 may communicate over the network 105 to request a webpage, for example, from the web client application server 114 of the organization computing system 104. For example, the client device 108 may be configured to execute the application 130 to receive a generated video clip from the organization computing system 104. The content that is displayed to the client device 108 may be transmitted from the web client application server 114 to the client device 108 and subsequently processed by the application 130 for display through a graphical user interface (GUI) of the client device 108.

FIG. 2 is a block diagram of a video clipping environment 200, according to one or more embodiments. The video clipping environment 200 may be configured to receive a video input and determine one or more clippings of the video input. The clippings may correspond to particular trigger events in sporting occasions. The video clipping environment 200 may include the data intake 201, client systems 208, the network 105, and the organization computing system 104.

The data intake 201 may include a broadcast module 202, an event data module 204, and/or the tracking system 102. Each or a subset of the components of the data intake 201 may be configured to distribute data to the organization computing system 104. The organization computing system 104 may include one or more APIs 238 to access respective data and data types from the data intake 201. The broadcast module 202 may include an external source configured to transfer a video stream and/or saved video footage to the organization computing system 104. The broadcast module 202 may be configured to send multiple video feeds simultaneously. For example, the broadcast module 202 may transfer video feed of all premier league sporting occasion (e.g., games) played throughout a season. The video feeds transferred may include timestamps. The organization computing system 104 may store the video feed within the data store 118 as broadcast data 222.

The event data module 204 may be configured to transfer event data objects of sporting occasions. The event data objects may be entered manually by a user or created by a computing system analyzing a sporting occasion, as discussed herein in reference to “event data”. The event data objects may be sent by the event data module 204 within seconds (e.g., within approximately 30 seconds, within approximately 5 minutes, etc.) of an event occurring during a sporting occasion. The event data objects may include play-by-play data of one or more sporting occasions data with respective timestamps and players involved. For example, an exemplary piece of data transferred may be that for a Manchester United vs. Everton sporting occasion that is currently taking place, player A scored a penalty goal at 42:37 timestamp. The organization computing system 104 may store the event data objects within the data store as event data 220. According to embodiments, event data objects may be generated manually or may be generated by a computing system, as discussed herein. A computing system may generate the event data objects by, for example, analyzing tracking data (e.g., from the tracking system 102 of FIG. 1), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession based event, play type event, etc.). Each event data object may include metadata including classification metrics defining the respective event data object, and players associated with the respective event data object. The classification metrics may define the type and characteristics of the respective event. For example, classification metrics may indicate whether an event is a shot, pass, tackle, foul, or other action type, along with sub-classifications such as shot accuracy, pass direction, or tackle outcome. The metadata may further include player identifiers that associate one or more players with the respective event data object, such as the player who performed the action and any players who were the target or recipient of the action. In some aspects, the metadata may also include positional information indicating where on the playing surface the event occurred and temporal information indicating the duration or sequence of the event relative to other events

The organization computing system 104 may receive tracking data from the tracking system 102 as described in FIG. 1. This tracking data may be stored as tracking data 224 within the data store 118.

The organization computing system 104 may be configured to compile and connect respective event data 220, the broadcast data 222, and the tracking data 224. For example, utilizing respective metadata (e.g., listed teams, date, and time) from each of the sources, the organization computing system 104 may connect and compile data and associate the data with a particular sporting occasion. For example, a particular video feed from the broadcast data 222 may be associated with the event data 220 and the tracking data 224 of that sporting occasion.

The data store 118 may further store saved rules for respective clients. For example, the saved rules may indicate first, for which events to generate video clips (the trigger events) (e.g., respective events, sporting occasions, and/or games for which to identify trigger events). The rules may further include video specific settings (e.g., resolution, aspect ratio, logos to add, etc.) for particular users or based on particular settings.

The qualifier module 122 and the clipping module 124, may access the respective rules, and upon an occurrence of a trigger event, in the event data 220, generate a video clip based on the trigger event. Upon the occurrence of a trigger event in the event data 220, the qualifier module 122 may analyze all event data objects in a set period of time prior to the trigger event (e.g., in the 15 seconds of lead up to the trigger event). The qualifier module 122 may use a machine learning model to determine a particular qualifier associated with the trigger event that further defines the trigger event. The machine learning model may be fine-tuned based on sequence training data to identify patterns of play based on based on event data objects. The qualifier may define the pattern of play in a lead up to the trigger event. For example, Table 1 below depicts an example qualifier for a trigger event of a goal in a soccer game.

TABLE 1

| Qualifier | Clipping Parameter |
|---|---|
| Open play/regular 6 or | 8 seconds before the goal scored timestamp |
| more continuous successful | |
| passes by the goal | |
| scoring team. | |
| Direct free-kick | 2 second before the kick |
| Set-piece | Beginning of the set-piece |
| Fast break | 14 seconds before the goal scored timestamp |
| Throw in | 2 seconds before the throw in is taken |
| Corner | 2 seconds before the corner is taken |
| Direct-corner | 2 second before the corner is taken |
| Penalty | 5 seconds before the goal |

As shown in Table 1, the qualifier module 122 may analyze event data objects and qualifiers in the lead up to the event to decide the optimal clipping points. For example, during a soccer game, if a shot on goal happened after a corner, the system may check the qualifiers of the shot or the sequence of play before to determine the starting for the highlight clip (in this case the corner event or if the corner event was taken more than 5 ball touches before, cut the highlight clip short as the length of the highlight could get too long).

Machine learning techniques may be implemented to refine clipping points that are initially determined (e.g., in accordance with Table 1). This refining may include incorporating an initial rule as the basis for generating a clip and then utilizing automated audio and scene detection to refine the clipping point to avoid start/end of clips in the middle a sentence or starting directly after a scene cut.

The techniques may include the qualifier module 122 implementing a mixture of large language models for time-based transcription of audio and scene detection models (e.g., PySceneDetect). In another example, an open play goal may still not capture all of the relevant action with the “8 seconds before” rules based techniques and the qualifier module 122 may implement machine learning techniques to identify when a commentator's voice starts to rise, or identify the best initial pass to start the clip from. Accordingly, in accordance with embodiments disclosed herein, an initial clipping point may be determined for a given trigger event based on its respective qualifiers. The initial clipping may be refined by a machine learning model that is trained in accordance with the techniques disclosed herein. The training may be based on a training data set that includes historical or simulated video feeds, historical or simulated qualifiers, historical or simulated video clips generated based on the video feeds and qualifiers, and/or the like. The trained machine learning model may receive, as inputs, one or more video feeds that include the trigger event, the initial clipping data (e.g., the durations or times to perform clippings), and/or one or more qualifiers associated with the trigger event. The machine learning model may include or may be in communication with an LLM that receives the video feed and extracts audio and/or scene information from the video feed to output break points in the audio and/or scene associated with the video feeds. The trained machine learning model may output updated video clipping data based on the break points output by the LLM such that the updated video clipping data corresponds to a break point prior to or proximate to the timings included in the initial video clipping data. For example, if the initial video clipping data indicates that a video should be clipped starting at a 45 second mark, the updated video clipping data may refine that starting point to the 43 second mark based on the LLM break point output. The 43 second mark may be the closest break point (e.g., the beginning of a sentence included in audio corresponding to the video feed) prior to the initial clipping 45 second mark. Accordingly, by implementing the techniques above, a video may be automatically clipped at a natural break point closest to an initial rule-based break, resulting in a more consumable video clip in comparison to a rule-based video clip.

Further, Table 2 below depicts an example qualifier for a trigger event of an own goal in a soccer game.

TABLE 2

| Qualifier | Clipping Parameters |
|---|---|
| Set piece | Beginning of the set-piece |
| Open play/regular | 8 seconds before the goal scored timestamp |
| Fast break | 8 seconds before the goal scored timestamp |
| Throw in | 2 seconds before the throw in is taken |

For example, the qualifier module 122 may determine that a trigger event of a goal should further be defined through the qualifier as a corner kick goal. In this example, the trigger event is the goal, and the qualifier is categorizing the goal as a corner kick goal. The qualifier module 122 may then determine a set period of time for the generated video clip.

The clipping module 124 may utilize the set period of time generated by the qualifier module 122 to access that respective video from the broadcast data 222. The clipping module 124 may consider multiple views and additional data such as player location (e.g., through the tracking data 224) to crop and generate a video clip. The clipping module 124 may further implement machine learning models to automatically crop the video clip to focus on key aspects of the trigger event, including dynamic framing adjustments and seamless transitions between different camera perspectives. The clipping module 124 may also be configured to overlay graphical content on the video clip, including augmented graphics displaying player positioning information, statistical data associated with the trigger event, expected goal (xG) values, expected pass values, expected threat values, distance measurements between players, and other data-driven visual elements. The corresponding event data 220 for a particular trigger event may be associated and stored as metadata for a generated video.

The organization computing system 104 may be configured to store generated videos and corresponding metadata and event in the video repository 228. The video repository 228 may include stored video files and corresponding metadata, including saved transcripts of audio associated with each video clip. The audio transcripts may be generated using speech recognition technology and stored alongside the video clips to enable audio-based searching and indexing within the video repository 228. The audio transcripts may include commentary, crowd noise, referee calls, and other audio elements captured during the sporting occasion. The video repository 228 may include a search function that allows users to search for video clips based on audio content, such as specific commentary phrases, player names mentioned by commentators, or particular audio events. The audio transcripts may also be utilized by the qualifier module 122 and the clipping module 124 to assist with determining optimal clipping parameters and refining clipping points based on audio cues, such as identifying when a commentator begins describing an action or when crowd excitement peaks. For example, FIG. 4 described below may show a user interface 400 of the video repository 228. The video repository 228 may include stored video files and corresponding metadata. The video repository 228 may be accessed by one or more client systems 208 and include a look-up/search function based on the respective metadata and tags. In some examples, the metadata may be stored as a sidecar file to respective video clips. In some aspects, the client device 108 as described in FIG. 1 may be representative of or included within the client systems 208, where the client systems 208 may encompass one or more client devices 108 that access the organization computing system 104 to retrieve generated video clips and configure video generation rules.

In some examples, the metadata may be stored as embedded within a header or other component of the video clip. The format of the metadata may be different than the format of the underlying file to which the metadata is appended (e.g., different than the format of a video clip file itself).

The organization computing system 104 may further be configured to generate and/or store one or more AI generated metric (e.g., AI metrics 226) for a respective player or team for a live sporting occasion. These metrics may be imported from an external source or determine by a separate machine learning system. The AI metrics 226 may be stored in the data store 118 and include metadata indicating a respective player or team associated with a respective AI metric. The clipping module 124 may be configured to search for particular AI metrics 226 related to a player or team in a generated video clip. In some examples, the AI metrics 226 may be overlaid on the generated video. For example, if an AI metric lists a percentage chance that a particular shot will result in a goal, then this statistic may be overlaid on a respective video of a goal to provide additional context and information to a viewer. In this way, the clipping module 124 may further enrich a generated video with additional generated content.

In some aspects, the system may implement a granular rating system to assign rating scores to trigger events. The rating system may provide a rating from approximately 0 to 100 that rates every event with a unique identifier relative to every other event of its kind.

The rating scores may be generated by a machine learning model configured to analyze characteristics of each trigger event and compare those characteristics against other trigger events of the same type. For example, a goal trigger event may be rated relative to other goal trigger events based on factors such as shot difficulty, defensive pressure, game context, and other performance metrics. The rating score may be stored as metadata associated with each generated video clip, enabling subsequent filtering, sorting, and selection operations based on the rating scores.

In some examples, the system may filter events based on a smart rating score threshold, such as selecting all events above a rating of, for example, 70 for a particular team. In some examples, the system may select events based on a smart rating percentile, such as picking the best or worst events based on the ratings to identify, for example, the top 10 events.

The rating system may be integrated with highlight package generation, where the rating may inherently pull the top rated events, such as the top 10 highest rated events of a selected type. For example, a user may configure a highlight package to automatically include the highest rated goals from a specified time period, competition, or set of teams. The system may automatically select and rank the video clips based on their associated rating scores to generate a highlight package that includes the most significant events.

In some aspects, the smart ratings may be used as the main trigger or main input for sorting video clips when generating highlight packages. The rating-based sorting may enable automated generation of highlight packages such as “best goals of the month” or “top plays of the weekend” without requiring manual curation or selection of individual clips.

For automated clips, the metadata may be extracted from the rating system and event data feeds and made available within a clip API. The metadata may include rating scores alongside other event information such as competition identifiers, event identifiers, timestamps, player identifiers, team identifiers, and event type classifications.

The video clipping environment 200 may further include the client systems 208. The client systems 208 may include one or more servers that may access the organization computing system 104. The client systems 208 may be configured to (1) select trigger events and corresponding settings (e.g., quality, ratio, file format, etc.) to for the system to generate videos of, and (2) receive videos of generated video clips from the organization computing system 104. The client systems 208 may include real-time access to video generated clips. The client systems 208 may further access a search function that allows for searching through the video repository 228 by metadata and audio transcripts, enabling content discovery based on spoken commentary, player names, or specific audio events captured during the sporting occasions.

For example, exemplary client systems 208, may configured to access a video on demand (“VOD”) platform or a subscription video on demand (“SVOD”), wherein the VOD or SVOD platform may be exemplary use case of the video repository 228 of FIG. 2. Exemplary client systems 208 may include league/clubs (e.g., sporting teams or leagues), media/publishers, broadcasters, rights holders, video AD networks, and/or video platforms.

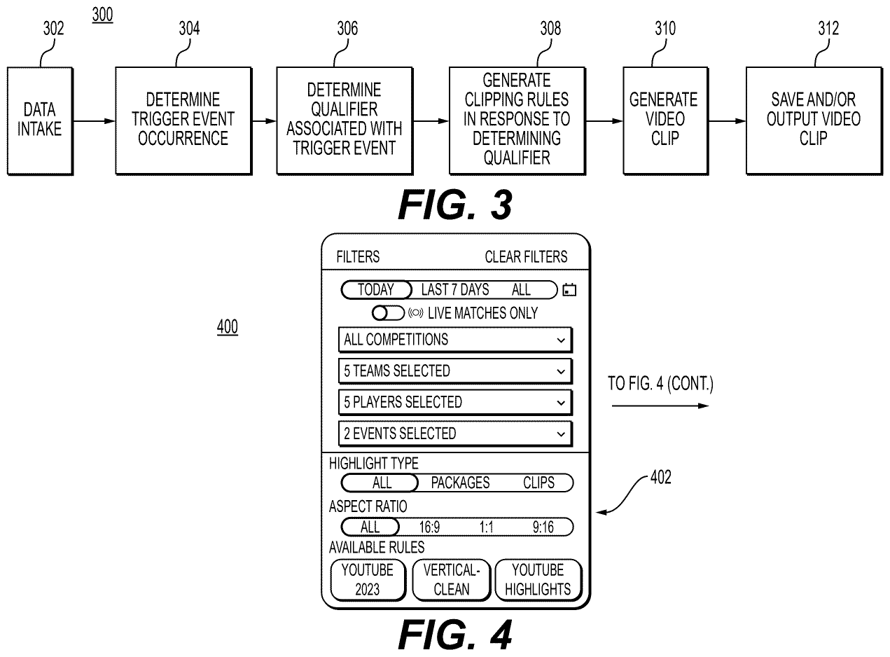

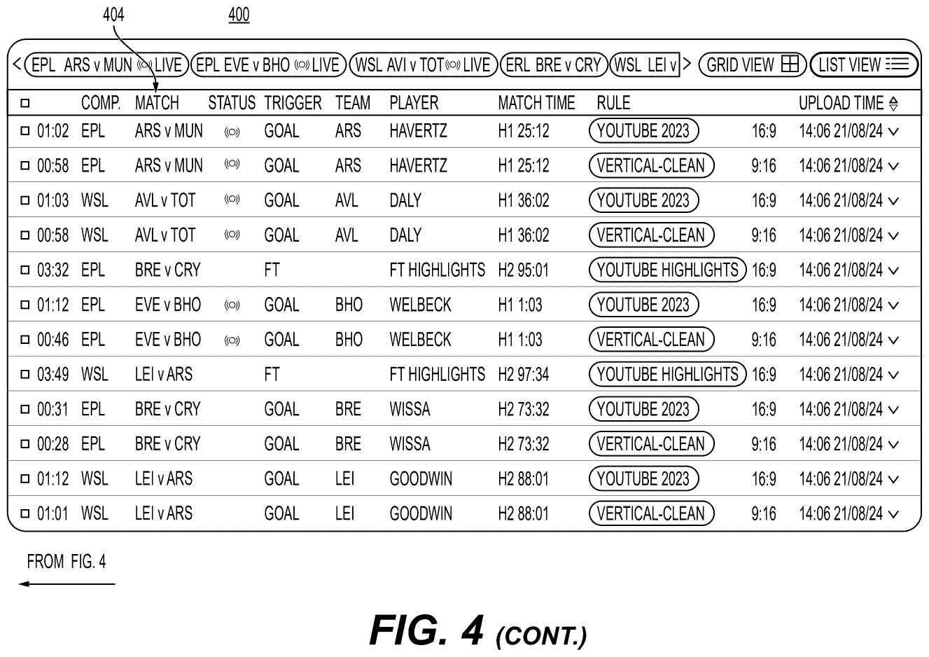

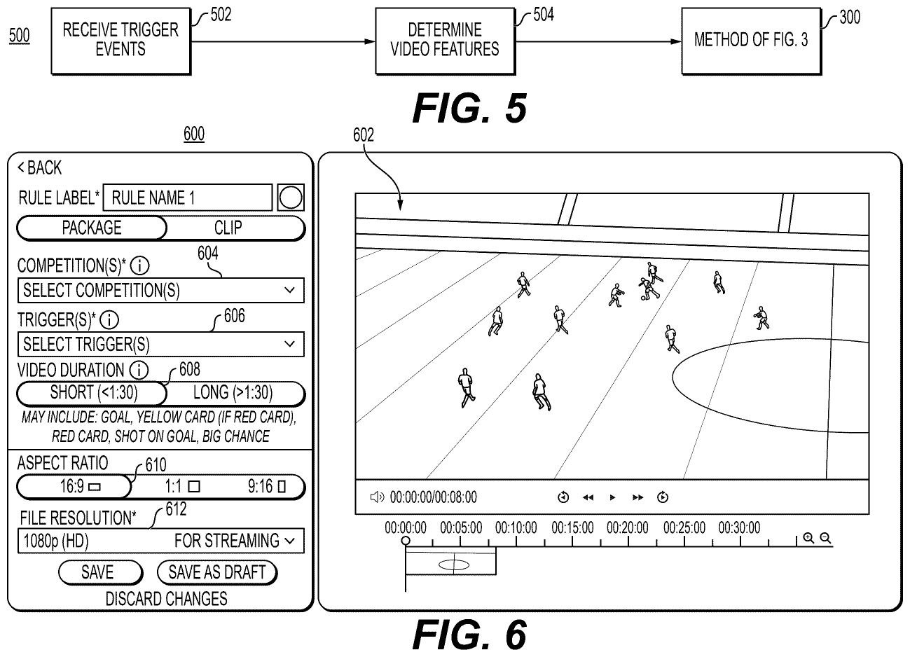

FIG. 3 is a flow diagram of an exemplary method 300 for implementing a machine learning model to generate a video clip, according to one or more embodiments. The method 300 may, for example, be implemented by the video clipping environment 200 and/or the computer environment 100. The method 300 may be an exemplary method for generating a video clip of a sporting occasion by implementing the techniques discussed herein.

At step 302, the system may include receiving a video feed of a sporting occasion (e.g., through the broadcast module 202 of FIG. 2). In some examples, the broadcast feed may be of a sporting occasion occurring live. In some examples, videos of sporting occasions may be uploaded. The sporting occasions may be for a variety of sports, including, but not limited to soccer, basketball, American football, rugby, cricket, tennis, team sports, individual sports, and/or the like. The video feed may include entire sporting occasions, including leading up to and immediately after the sporting occasion has concluded. The video feed may be received in various formats and resolutions, including high-definition (HD), ultra-high-definition (UHD), or standard-definition formats, and may include multiple camera angles or perspectives of the sporting occasion. The video feed may further include associated audio data, such as commentary, crowd noise, referee calls, and ambient sound captured during the sporting occasion. In some examples, the video feed may include embedded metadata such as frame timestamps, camera identifiers, broadcast channel information, and encoding parameters. The video feed may be received as a continuous stream during live events or as discrete video files for previously recorded events. In some examples, the system may receive multiple simultaneous video feeds from different camera positions, including wide-angle views, close-up shots, aerial perspectives, and goal-line or boundary cameras. In some examples, the system may access a video repository (e.g., the video repository 228 of FIG. 2) to retrieve video feed of sporting occasions that have occurred in the past or have been uploaded to the system.

At step 302, the system may further include receiving event data objects of the sporting occasion (e.g., through the event data module 204 of FIG. 2). The event data objects may be associated with the video feed of the sporting occasion. Each event data object may represent an action in the sporting occasion. Each data object may further include metadata and timestamps of when the event occurred. The event data objects may include pre-defined actions that occur during a sporting occasion. These event data objects may be created manually or automatically generated. Event data objects may be received throughout the sporting occasion describing each action in the sporting occasion. Exemplary metadata for event data objects may include classification metrics that define the respective event and players associated with the respective event. An exemplary event data object and corresponding metadata may be that a pass occurred by player A to player B at time 43:07 into game C between players X and Y. Further metadata may include the region the players were in during the pass.

The event data objects may further include positional coordinates indicating where on the playing surface the action occurred, such as pitch zones, court regions, or field sections. In some aspects, the event data objects may include velocity information associated with objects or players involved in the action, such as ball speed during a shot or pass, or player running speed during a sprint or tackle. The event data objects may also include directional information indicating the trajectory of movement for players or objects, such as pass direction, shot angle, or player movement vectors.

In some cases, the event data objects may include contextual information related to the sporting occasion state at the time of the action, such as current score, time remaining, possession count, or period of play. The event data objects may further include formation data indicating team tactical arrangements at the time of the action, defensive line positions, or pressing intensity metrics. In some aspects, the event data objects may include pressure metrics indicating the level of defensive pressure applied to a player at the time of an action, which may be calculated based on proximity and positioning of opposing players.

The event data objects may also include outcome information associated with each action, such as whether a pass was successful or intercepted, whether a shot was on target or blocked, or whether a tackle resulted in possession change. In some examples, the event data objects may include chain identifiers that link related actions together, such as connecting a sequence of passes that form a single possession or linking a foul to a subsequent free kick. The event data objects may further include body part information indicating which body part a player used to perform an action, such as left foot, right foot, or header for shots and passes.

In some aspects, the event data objects may include referee decision data indicating official rulings associated with actions, such as foul calls, offside decisions, or card issuances. The event data objects may also include substitution information, injury stoppages, and other match administration events that affect the flow of play. The event data objects may further include set piece classification data that categorizes actions as occurring during open play, corner kicks, free kicks, throw-ins, goal kicks, or penalty situations.

The timestamp of the event data objects and the time into the broadcast footage may be fused so that timestamps for events accurately depict actions occurring in the video feed. The system may receive tracking data for the sporting occasion. This data may further be extracted and supplemented with the event data objects.

In some aspects, the system may also receive graphic overlay data or generated statistics at this step, which may be associated with the event data objects or video data. The graphic overlay data may include pre-rendered visual elements such as player name tags, score displays, possession indicators, or tactical diagrams that correspond to specific timestamps within the video feed. The generated statistics may include performance metrics, probability calculations, or analytical insights derived from the event data objects and tracking data. In some cases, these graphic overlays or generated statistics may be produced by a separate machine learning model configured to analyze the sporting occasion and output relevant visual or statistical content. For example, a machine learning model may generate expected goal values, pass completion probabilities, or player heat maps based on the received event data objects and tracking data. The graphic overlay data and generated statistics may be synchronized with the video feed timestamps to enable the clipping module 124 of FIG. 1 and FIG. 2 to incorporate these elements into generated video clips at appropriate moments during playback.

At step 304, the system (e.g., via the organization computing system 104 of FIG. 1 and FIG. 2) may determine, based on the received event data objects, that a trigger event occurred. The trigger event may be a predefined action in the sporting occasion. As described in FIG. 5 below, the trigger events may be preselected or dynamically determined events for which a user or automated system has requested a video clip. The system may be determined to review each incoming event data object and determine that a trigger event occurred. Exemplary trigger events for a soccer game may include, but are not limited to, a goal, yellow card, red card, shot on goal, shot, big chance, clearance, block, penalty, free-kick, corner, interception, foul, pass, and tackle.

In some aspects, the trigger event may be based on audio analysis of the broadcast feed. The system may implement audio processing techniques to monitor commentary patterns, crowd noise levels, or announcer vocal characteristics throughout the sporting occasion. For example, a sudden increase in crowd volume or a change in announcer speech patterns, such as increased speaking rate or elevated pitch, may indicate an exciting moment during the sporting occasion. When audio excitement levels exceed a threshold value, this may be considered a trigger event and a video clip may be generated. The audio analysis may be performed by a machine learning model trained to recognize patterns in sports broadcast audio that correlate with noteworthy events. In some cases, specific words or phrases received as inputs (e.g., spoken by the commentator) may serve as trigger events, such as when a commentator exclaims particular terms associated with scoring plays, near misses, or controversial decisions, which the system may detect through speech recognition and natural language processing techniques.

In some cases, the trigger event may be based on scene detection within the video feed. The system may analyze visual characteristics of the broadcast to identify camera cuts, replay sequences, or slow-motion segments that typically accompany significant events. When the system detects a pattern of camera behavior associated with important moments, such as multiple rapid camera angle changes followed by replay footage, this detection may serve as a trigger event.

In some examples, the trigger event may be based on scoreboard or on-screen graphic changes detected through optical character recognition techniques. The system may monitor the broadcast overlay for changes in score, time, or other displayed statistics. When a score change is detected, this may automatically generate a trigger event for the corresponding goal or scoring play.

In some aspects, the trigger event may be based on player tracking data indicating unusual movement patterns. For example, when tracking data reveals that multiple players are converging on a single location at high velocity, or when a player's speed exceeds a threshold value during a particular action, this may indicate a significant event worthy of clipping.

In some cases, the trigger event may be based on formation analysis derived from tracking data. When the system detects a significant tactical shift, such as a team transitioning from a defensive to an attacking formation, or when defensive line positions change substantially, this may serve as a trigger event for capturing tactical moments.

In some examples, the trigger event may be based on pressure metrics calculated from player positioning data. When a player receives the ball under high defensive pressure, as determined by the proximity and positioning of opposing players, this may generate a trigger event for capturing skill-based moments or defensive actions.

In some aspects, the trigger event may be based on ball trajectory analysis. When the system detects that a ball is traveling toward the goal at a velocity or angle that suggests a potential scoring opportunity, this trajectory information may serve as a trigger event even before the outcome of the shot is determined.

In some cases, the trigger event may be based on referee signals or official decisions detected through video analysis. The system may be trained to recognize referee gestures, such as pointing to the penalty spot or raising a card, and generate trigger events based on these detected signals.

In some aspects, the trigger event may be based on xG, momentum, insights, or excitement data. These may be machine learning generated trigger events. For example, xG may refer to a chance of a particular play resulting in a goal as output by a machine learning model based on inputs such as a video feed, tracking data, and/or event data objects in accordance with techniques disclosed herein. The xG may also refer to a likelihood of success of a goal scoring performance. The xG may be assigned to actions in a sporting occasion, such as a direct kick from a particular area. The xG score may be a continuous value between 0 and 1. The xG score may be generated by a separate machine learning model. When an xG for a play exceeds a threshold value, the generated may become a trigger event. For example, the system described herein may be set (e.g., by a user) to generate a soccer shot video clip when the xG qualifier is >0.5 during a sporting occasion.

In some examples, the generated video clip of the trigger event may be based on momentum. Momentum may be defined by a momentum metric. The momentum metric may consider each team's possession values by relating them to each other to determine which team had momentum at certain points in the event. The momentum metric may be determined by a separate machine learning model. When a momentum metric exceeds a threshold value, a trigger event may be initiated.

In some aspects, the system may generate a momentum-based highlight package by analyzing momentum data throughout a sporting occasion. The system may create a momentum-based highlights package that identifies the key events that drove the momentum up and down during the course of a sporting occasion, and generate a video clip based on those identified events. The momentum metric may consider each team's possession values by relating them to each other to determine which team had momentum at certain points in the sporting occasion.

In some examples, the clipping module 124 may access momentum data stored in the data store 118 and identify trigger events that correspond to significant momentum shifts during the sporting occasion. The system may analyze the momentum data to detect inflection points where momentum changed from one team to another, or where momentum values exceeded threshold levels indicating particularly significant moments. The identified trigger events may then be used to generate individual video clips that are subsequently combined into a momentum-based highlight package.

The momentum-based highlight package may provide a narrative representation of the sporting occasion by capturing the events that most significantly influenced the flow and outcome of the sporting occasion. For example, in a soccer match, the momentum-based highlight package may include video clips of events such as goals, near misses, defensive stops, or tactical changes that caused measurable shifts in momentum between the competing teams. The system may automatically select and sequence the video clips based on the magnitude of the momentum change associated with each event, prioritizing events that caused the largest momentum shifts.

In some aspects, the system may implement AI-dominated storytelling features that study the match proceedings to auto-generate ideal stories to showcase the match. The momentum-based highlight package may be generated with minimal user intervention, where the system automatically determines which events to include based on the match proceedings and associated momentum data. The system may apply intelligent sequencing algorithms to arrange the selected clips in an order that reflects the momentum narrative of the sporting occasion, such as chronological order or order based on momentum impact magnitude.

In some examples, the momentum data may be generated by a separate machine learning model configured to analyze event data objects, tracking data, and other performance metrics to calculate momentum values throughout the sporting occasion. The momentum values may be stored as metadata associated with each event data object, enabling the clipping module 124 to filter and select events based on their associated momentum impact when generating highlight packages.

In some examples, the trigger event may be based on insights. Insights may relate to various aspects of performance of a player in the sporting occasion. The insights may be determined by a separate machine learning model. For example, insights may be related to defensive performance, such as to derive fitness metrics for the player or to predict a load for the player. Particular insights may be assigned to generate a trigger event during a sporting occasion.

In some examples, the generated video clip of the trigger event may be based on excitement data. The phrase “excitement data” may refer to any data that indicates that a program and/or a portion of a program (such as a broadcast of a sports sporting occasion, or any other media programming) may be exciting or otherwise of interest or potential interest to a viewer. Excitement data may include audio data associated with the sporting occasion, such as crowd noise levels or announcer vocal patterns. For example, a sudden increase in crowd volume may indicate an exciting moment during the sporting occasion, such as a near miss, a controversial call, or an impressive play. Similarly, changes in announcer speech patterns, such as increased speaking rate, elevated pitch, or heightened vocal intensity, may signal that a noteworthy event is occurring or about to occur. The system may implement audio processing techniques to monitor decibel levels, frequency patterns, or speech characteristics throughout the sporting occasion. When the excitement data indicates that crowd noise or announcer excitement exceeds a threshold value, this may be considered a trigger event, and a video clip may be generated. In some aspects, specific input phrases (e.g., spoken by the commentator or an individual) may denote excitement and serve as indicators for trigger event detection. For example, clips may begin early or end late when corresponding excitement levels are peaking during the sporting occasion. In some cases, the excitement data-based trigger event generation may be combined with other trigger event detection methods, such as event data object analysis or machine learning generated metrics, to improve the accuracy of identifying significant moments within the sporting occasion. The audio analysis may be performed by a machine learning model trained to recognize patterns in sports broadcast audio that correlate with exciting or noteworthy events.

At step 306, the system may determine a qualifier associated with the trigger event. This determination may include using a machine learning model (e.g., via the qualifier module 122 of FIG. 1 and FIG. 2) to determine the qualifier. This determining may include analyzing, using the machine learning model, a portion of the event data objects with timestamps prior to the trigger event. For example, all event data objects received 10, 15, or 20 seconds prior to the trigger event may be reviewed. In some examples, a set number of preceding event data objects may be reviewed. The machine learning model may have been trained to identify particular qualifiers associated with a particular trigger event. The machine learning model may be trained using supervised learning techniques, where training data includes historical sporting occasions with labeled trigger events and corresponding qualifiers. The training data may include sequences of event data objects that precede various types of trigger events, with each sequence annotated with the appropriate qualifier classification. The machine learning model may implement neural network architectures, such as recurrent neural networks (RNNs) or long short-term memory (LSTM) networks, which are configured to process sequential event data objects and identify temporal patterns indicative of specific qualifiers. In some embodiments, the machine learning model may utilize attention mechanisms to weigh the importance of different event data objects within the sequence when determining the qualifier. The machine learning model may be trained to recognize patterns such as the number of consecutive passes, the spatial progression of play across the playing surface, the velocity of ball movement, and the positioning of players relative to defensive formations. The machine learning model may output a probability distribution across multiple potential qualifiers, and the system may select the qualifier with the highest probability score. In some cases, the qualifier determination may be rules based, where predefined logical conditions are evaluated against the event data objects. In other cases, the qualifier may be generated entirely by the machine learning model based on learned patterns from the training data. In some embodiments, a hybrid approach may be employed where rules-based techniques provide initial qualifier candidates that are subsequently refined or validated by the machine learning model. The qualifier may provide context related to the trigger event, enabling the system to subsequently determine appropriate clipping parameters that capture the relevant buildup and aftermath of the trigger event.

In some embodiments, the qualifier may be determined using rules-based approaches that evaluate predefined conditions against the event data objects. The rules-based approach may involve establishing predefined criteria that correspond to specific qualifiers. For example, a qualifier may be assigned based on whether a preceding event of a particular type occurred prior to the trigger event. The system may access a rules database or lookup table that associates specific event patterns with corresponding qualifiers. For instance, if a free kick event occurred prior to a goal, the system may apply a rule that assigns a “direct free kick” qualifier to the goal trigger event. Similarly, if a corner kick event occurred prior to the goal, the system may assign a “corner” qualifier. The rules-based approach may utilize configurable criteria that maybe adjusted based on the specific sport, competition, or user preferences. The system may evaluate multiple rules in sequence or in parallel to determine the most appropriate qualifier for a given trigger event. In some cases, the rules-based approach may be combined with machine learning techniques, where the machine learning model refines or validates the qualifier determined through rules-based analysis.

In an example scenario, the trigger event may be a goal in a soccer sporting occasion. Potential qualifiers that may be identified may include open play (e.g., where more than six passes occurred prior to the goal), a direct free kick, a set-piece, a fast break, a throw-in, a corner, a direct corner, and a penalty. The determination of the qualifier may involve analyzing the sequence of event data objects preceding the trigger event to identify characteristic patterns associated with each qualifier type. For example, to determine whether a goal qualifies as a fast break, the system may analyze tracking data and event data objects to identify patterns of rapid ball progression and player movement prior to the goal. To determine whether a goal qualifies as open play, the system may count the number of consecutive successful passes by the goal-scoring team prior to the goal and compare this count against a minimum threshold, such as six or more passes. The qualifier determination process may also consider the spatial location of preceding events, such as whether a preceding event occurred in a specific zone of the playing surface. The system may apply hierarchical rules to resolve conflicts when multiple qualifiers could potentially apply to a single trigger event, prioritizing certain qualifier types over others based on predefined precedence rules or machine learning-based relevance scoring.

At step 308, the system (e.g., via the qualifier module 122 of FIG. 1 and FIG. 2) generate clipping parameters in response to the determined qualifier from step 306. The clipping parameters define timing parameters and time intervals for the video clip based on the qualifier. For example, particular events and their corresponding qualifier may lead to different time intervals being relevant to the trigger event. The clipping parameters may specify how much time before and after the trigger event should be included in the video clip. For instance, a goal with a “fast break” qualifier may require a longer lead-up time interval (e.g., 14 seconds before the goal) compared to a goal with a “direct free kick” qualifier (e.g., 2 seconds before the kick). The machine learning model may determine what relevant time interval of the broadcast feed to clip based on the qualifier. The determination may be based on all relevant aspects of the trigger event including the lead up. The determination may further be based on celebration or relevant aspects of the trigger event that occurs after the action. In some examples, this process may include determining the relevant time interval of the broadcast feed from step 302.

The clipping parameters may be generated based on accessing a lookup table or other database that associates the determined qualifier with corresponding timing parameters for a trigger event. The lookup table may specify, for each qualifier type, the time interval before the trigger event timestamp and the time interval after the trigger event timestamp to include in the video clip. Alternatively, or in addition, one or more clipping parameters may be automatically generated using a clipping parameter machine learning model. Such a clipping parameter machine learning model may be trained based on training data sets that include historical or simulated sporting occasions, trigger events, training data, video feeds, qualifiers, video clips, highlight clips, and/or the like. The clipping parameter machine learning model may be trained to determine optimal clipping parameters and timing parameters for given trigger events and their respective qualifiers based on, for example, training data sets that include historical or simulated clips and their correlations to inference inputs to a trained clipping parameter machine learning model. The clipping parameter machine learning model may be trained to output clipping parameters based on inputs which may include an indication of trigger event, a qualifier, and/or a video feed that includes the trigger event. Accordingly, the clipping parameter machine learning model may output clipping parameters including timing parameters based on associating such inputs with the trained model such that the output clipping parameters correspond to capturing video content that most closely resembles the types and duration of content from the video clips and/or highlight clips of the training data set. In doing so, the clipping parameters may enable automated generation of video clips that meet or exceed the quality of previously manually generated video or highlight clips. In some examples, machine learning techniques may implement rules to determine an initial set of clipping parameters and timing parameters, and then based on additional data such as audio, scene cuts, and player celebrations refine clipping parameters further.

At step 310, the system (e.g., via the clipping module 124 if FIG. 1 and FIG. 2) may generate a video clip of the trigger event. The generation may be based upon the determined clipping parameters and associated time interval(s) from step 308. The video clip generation process may involve multiple stages of processing to produce a polished, consumable video output.

In some examples, a basic cut of the video feed may be extracted based on the timeline determined from the clipping parameters. The basic cut may represent a raw segment of the broadcast data 222 corresponding to the time interval specified by the clipping parameters. The system may access the broadcast data 222 stored in the data store 118 and extract the relevant video frames based on the start and end timestamps derived from the clipping parameters.

Next, various user selected rules such as quality, aspect ratio, logos, pre-roll content, and post-roll content may be applied to the video. The system may access saved rules associated with a particular client or user from the data store 118 to determine the appropriate video specifications. For example, the system may apply resolution settings such as 1920×1080 for landscape format, 1080×1920 for portrait format, or 1080×1080 for square format based on user preferences. The system may further apply bit-rate settings, frame rate configurations, and file format specifications such as MP4 encoding. Logo overlays may be positioned in designated locations such as the top right, top left, bottom right, or bottom left corners of the video frame. Pre-roll and post-roll video segments or images may be appended to the beginning and end of the video clip, respectively, to provide branding or contextual information.

In some examples, a machine learning model may be used to generate the video clip. For example, the video clip may include fusions of multiple video feeds of the sporting occasion put together by a machine learning model. The machine learning model may analyze multiple camera angles captured during the trigger event and select optimal perspectives to create a cohesive viewing experience. The machine learning model may implement automatic camera angle selection based on the type of trigger event and qualifier, ensuring that the most relevant visual perspective is presented to the viewer. The machine learning model may further implement seamless transitions between different camera perspectives, creating smooth visual flow throughout the video clip.

In another example, the machine learning model may incorporate the tracking data 224 to ensure all relevant players are included in the cropping of the video clip. The tracking data 224 may provide positional coordinates of players and objects throughout the video segment, enabling the machine learning model to dynamically adjust the display area to follow key participants in the trigger event. The machine learning model may identify the primary players involved in the trigger event based on the event data 220 and ensure that these players remain visible within the cropped frame throughout the video clip. Dynamic framing adjustments may be applied to maintain focus on the action while accommodating player movements across the playing surface.

In some aspects, the system may utilize tracking data to perform intelligent cropping by first identifying the set of players associated with the trigger event from the event data objects. The tracking data may provide frame-by-frame positional coordinates for each identified player, represented as x and y coordinates relative to the playing surface. The system may calculate a bounding region that encompasses all relevant players at each frame by determining the minimum and maximum x and y coordinates among the identified players and adding a configurable margin around this region. As players move throughout the duration of the video clip, the system may continuously recalculate this bounding region to ensure that the cropped frame dynamically adjusts to keep all relevant players within the visible area. The system may apply smoothing algorithms to the bounding region calculations to prevent abrupt or jarring movements in the cropped output, interpolating between consecutive frame positions to create fluid camera-like motion that follows the action naturally.

In some cases, the tracking data may also include ball position information, which the system may incorporate into the cropping calculations to ensure that both the ball and the relevant players remain visible within the cropped frame. The system may weigh the importance of different tracked objects based on the type of trigger event and qualifier, such as prioritizing the goal scorer and the ball during a goal event while also including nearby defenders or the goalkeeper when contextually relevant. When the spatial distribution of relevant players exceeds the dimensions achievable within the target aspect ratio, the system may implement prioritization logic to determine which players are most relevant to include, potentially based on their proximity to the ball, their role in the trigger event as indicated by the event data objects, or their movement vectors derived from sequential tracking data frames. The system may also detect scene cuts within the broadcast feed and reset the cropping parameters at each cut to account for changes in camera perspective that would invalidate the previous tracking-based cropping calculations.

In another example, the machine learning model may be configured to overlay AI insights on the video clip. The AI insights may include graphical content such as augmented graphics displaying player positioning information, statistical data associated with the trigger event, expected goal (xG) values, expected pass values, expected threat values, distance measurements between players, defensive line visualizations, pass trajectory indicators, and other data-driven visual elements. The system may access the AI metrics 226 stored in the data store 118 to retrieve relevant statistical information associated with the players, teams, or events depicted in the video clip. The overlay placement and timing may be determined by the machine learning model to ensure that the graphical content enhances rather than obscures the underlying video content.

The video clip generation process may further include audio processing to ensure that the audio track accompanying the video clip is properly synchronized and appropriately trimmed. The system may analyze the audio content to identify natural break points, such as pauses in commentary or transitions in crowd noise, to refine the start and end points of the audio track. In some examples, the system may provide options to swap audio tracks, such as replacing original broadcast commentary with alternative language commentary or ambient sound.

For example, specific techniques of clipping may be applied based on a particular trigger event and corresponding qualifier. For example, if the trigger event is a goal and the qualifier defines the goal as based on a corner kick, the generated video clip may capture the corner kick setup, the delivery of the ball, the goal itself, and an ensuing celebration. The clipping module 124 may further identify and incorporate replay footage of the goal from alternative camera angles, automatically detecting when replay segments begin and end within the broadcast feed to seamlessly integrate them into the generated video clip. The system may apply transition effects between the live action footage and replay segments to create a professional-quality viewing experience.

At step 312, the generated video clip from step 310 may be saved and/or output to one or more users or databases. For example, the generated video clip with corresponding metadata from the event data objects associated with the trigger event may be stored with the video. The video and metadata may be saved in a video repository (e.g., the video repository 228 of FIG. 2). This video repository may be accessed by one or more users (e.g., the client systems 208 of FIG. 2). The metadata may be stored in various formats, including as a sidecar file associated with the video clip, embedded within a header or other component of the video clip file, or stored in a separate database with references linking the metadata to the corresponding video clip. Exemplary metadata may include a player associated with the trigger event, a team associated with the trigger event, a date associated with the sporting occasion, a timestamp associated with the trigger event, the determined qualifier, the trigger event type, competition information, match score at the time of the trigger event, and statistical metrics associated with the trigger event. The metadata may further include audio transcript information generated from the video clip, enabling audio-based searching and indexing. In an exemplary case, the generated video may have a file format of MP4, a bitrate of 8 Mbps, a frame rate of 25 fps, and a resolution of 1920×1080 for landscape format, 1080×1920 for portrait format, or 1080×1080 for square format.

According to an embodiment, the system may be configured to save clipping parameters without immediately generating the corresponding video clip. In this embodiment, upon determining a trigger event and its associated qualifier at steps 304 through 308, the system may store the clipping parameters, trigger event information, qualifier data, and references to the relevant portions of the broadcast data 222 in the data store 118 without executing the video clip generation process of step 310. The stored clipping parameters may include the determined time intervals, video format specifications, overlay configurations, and other generation parameters. When a user subsequently requests the video clip through a client system 208 or through a query to the video repository 228, the system may retrieve the stored clipping parameters and generate the video clip on demand. This deferred generation approach provides several technical benefits. First, the approach reduces computational resource consumption during live sporting occasions by avoiding the generation of video clips that may never be requested or viewed, thereby conserving processing power, memory, and storage capacity for higher-priority operations. Second, the approach enables the system to process a larger number of concurrent sporting occasions by distributing the computational load of video generation over time rather than concentrating the processing during live broadcasts. Third, the approach allows users to customize video generation parameters at the time of request, enabling the application of updated format specifications, resolution settings, or overlay configurations that may not have been available or selected at the time the trigger event occurred. Fourth, the approach reduces storage requirements by avoiding the generation and storage of multiple video clip variants for different aspect ratios, resolutions, or formats until specific variants are requested. The system may maintain the stored clipping parameters for a configurable retention period, enabling on-demand generation of video clips for historical trigger events while managing storage resources efficiently.

The method 300 of FIG. 3 may occur each time that a trigger event occurs throughout a particular sporting occasion. In some examples, method 300 may occur for particular clients whenever predefined trigger events occur. In some examples, method 300 may occur for any potential trigger event that a client server (e.g., client systems 208 of FIG. 2) may select and save to a video repository (e.g., video repository 228 of FIG. 2). The method 300 may be applied across various temporal contexts and use cases. For example, method 300 may be configured to execute for a single upcoming sporting occasion, wherein the system monitors the live broadcast feed and generates video clips in real-time or near real-time as trigger events occur during the sporting occasion. In another example, method 300 may be configured to execute for a defined period of time, such as an entire season, a tournament, a specific week of matches, or a multi-day competition, wherein the system continuously monitors multiple sporting occasions and generates video clips for trigger events occurring across all monitored events during the specified time period. In some examples, method 300 may be applied to past events by accessing historical broadcast data and event data stored in the video repository 228 or the data store 118, enabling the generation of video clips for trigger events that occurred in previously recorded sporting occasions. This retrospective application of method 300 may be initiated through user queries, automated batch processing, or scheduled jobs that process archived sporting occasion data. In some examples, method 300 may be applied to generate video clips for a specific competition or league, wherein the system is configured to monitor and process all sporting occasions within the designated competition. In some examples, method 300 may be applied selectively to sporting occasions involving specific teams or players of interest, enabling targeted video clip generation based on user preferences or subscription configurations. The flexibility of method 300 allows the system to support both live content generation for immediate distribution and historical content generation for archival purposes, content discovery, or retrospective analysis.

FIG. 4 is an exemplary user interface 400 for a client system to select video clipping outputs, according to one or more embodiments. The user interface 400 displays a panel 402 with potential options/settings/rules/filters a client server (e.g., the client systems 208 of FIG. 2) may create for defining when to create a video clip of a trigger event. For example, the client may select a filter of which days to create video clips, for what competitions, what teams, what events, what type of highlights (e.g., all trigger events, select trigger events, or combinations of trigger events), aspect ratio and video formats. The user interface 400 may further display a video repository 404, which may incorporate all aspects of the video repository 228 described in FIG. 2 above. As shown in the video repository 404, generated video clips of trigger events may be shown with respective metadata. This metadata associated with video clips may include sporting occasion (e.g., ARS v MUN), timestamp, competition, status, trigger event recorded, team associated with trigger event, player associated with trigger event, match time of trigger event, video type, aspect ratio, and time that the video was generated.

The user interface 400 may further include interactive elements that enable users to perform various operations on the displayed video clips within the video repository 404. For example, the user interface 400 may include view toggle options that allow users to switch between a grid view and a list view for displaying the video clips, enabling users to select a presentation format that best suits their workflow and content review preferences. The user interface 400 may also provide sorting and filtering capabilities that allow users to organize the displayed video clips based on various metadata attributes, such as sorting by generation time, match time, competition, or trigger event type. Additionally, the user interface 400 may include selection mechanisms that enable users to select one or more video clips for batch operations, such as downloading multiple clips, combining selected clips into a highlight package, or applying additional processing rules to the selected content. The panel 402 may include saved rule configurations, such as “YOUTUBE 2023” or “VERTICAL-CLEAN,” which represent predefined combinations of settings that users may apply to streamline the video clip generation process. These saved rules enable users to quickly apply consistent formatting and configuration parameters across multiple video generation sessions without manually configuring each setting individually.

FIG. 5 is a flow diagram of an exemplary method 500 for generating video clips of a sporting occasion, according to one or more embodiments. The method 500 may be implemented by video clipping environment 200 and/or computer environment 100. The method 500 may display a process for a user selecting which trigger events to create video clips of. The method 500 may enable users to configure comprehensive video generation parameters that govern how the system automatically produces video content from sporting occasions. By implementing the method 500, users may establish persistent rules that apply across multiple sporting occasions, enabling consistent and automated video clip generation without requiring manual intervention for each individual trigger event occurrence.

At step 502, a user (e.g., via the client systems 208 of FIG. 2) may choose respective trigger events for which to create videos. This analysis may be done specifically for each clip and define the central action being recorded in a video clip. The user may select from a predefined list of trigger events that are available for the particular sport or competition being monitored. For example, in soccer, the user may select trigger events such as goals, shots on goal, penalties, corners, free kicks, yellow cards, red cards, big chances, clearances, blocks, interceptions, fouls, passes, or tackles. The user may select multiple trigger events simultaneously, enabling the system to generate video clips for each selected trigger event type as they occur during the sporting occasion. The selection of trigger events may be saved as part of a rule configuration that persists across multiple sporting occasions, allowing the user to establish consistent video generation criteria without needing to reconfigure settings for each individual match or competition. In some examples, the user may configure different trigger event selections for different competitions, teams, or time periods, enabling customized video generation based on specific content requirements or audience preferences.

At step 504, a user may determine video features (e.g., filters) to define the created video clips. FIG. 6 depicts a user interface 600 for selecting video generation settings, according to one or more embodiments. FIG. 6 may display an exemplary interface 602 with video features that may be selected at step 504. For example, features/filters may include competitions 604, video duration 608, aspect ratio 610, and file resolution 612. FIG. 6 further depicts where a trigger 606 may be selected for a user (i.e., for step 502). FIG. 6 may show an exemplary snapshot from an exemplary video clip being created based on the features from step 504. The video features selected at step 504 define the technical specifications and presentation characteristics of the generated video clips. The user may configure multiple output formats simultaneously, enabling the system to generate multiple versions of each video clip with different aspect ratios, resolutions, or other characteristics to support distribution across various platforms and channels. For example, a user may configure the system to generate both a 16:9 landscape version for traditional broadcast or web viewing and a 9:16 portrait version for mobile social media platforms from the same trigger event. The system may automatically generate these multiple clip versions in parallel, ensuring that content is immediately available in all required formats upon the occurrence of a trigger event.

Exemplary feature/filters that may be selected are shown in Table 3 below.

TABLE 3

| Resolution Type | Pixels | Ratio |
|---|---|---|
| Landscape | 1920 × 1080 | 16:9 |
| Portrait | 1080 × 1920 | 9:16 |
| Square | 1080 × 1080 | 1:1 |

Additionally, at step 504 a user may select a logo to include on the generate clip or package. For example, the logo may be user specific and placed in either the top right, top left, bottom right, or bottom left of the video. In some examples, the logo may be animated. The logo configuration may enable users to apply consistent branding across all generated video clips, ensuring that content distributed through various channels maintains organizational identity and meets sponsorship or licensing requirements. The system may store multiple logo configurations, allowing users to select different logos for different competitions, platforms, or content types. In some examples, the logo placement and sizing may be automatically adjusted based on the selected aspect ratio to ensure optimal visibility and aesthetic presentation across different video formats.

Upon completion of step 504, method 300 of FIG. 3 may be applied to generate videos for one or more users. The configured rules from method 500 may serve as persistent parameters that govern the automated video generation process implemented by method 300. When a trigger event occurs during a monitored sporting occasion, the system automatically applies the user-configured rules to generate video clips that conform to the specified technical and presentation requirements. This integration between method 500 and method 300 enables a streamlined workflow where users configure their preferences once and receive automatically generated video content that meets their specifications without requiring ongoing manual intervention.

In some examples, a user may implement method 500 to create a package of multiple videos. For example, the system described herein may be configured to clip together multiple videos created using the techniques described in method 300 and method 500. The combination of multiple video clips may be stacked together and referred to as a package. This process may allow for multiple clips to be generated individually and then stitched together into a cohesive highlight package that presents a comprehensive view of significant moments from a sporting occasion. The stitching process may involve applying transition effects between individual clips, normalizing audio levels across the combined content, and ensuring visual consistency throughout the assembled package. For example, when combining generated videos of replays of an exemplary goal into the main clip (e.g., a package), the system may implement machine learning techniques to automatically identify when the replay starts/ends to stitch the video into the main event clip. The machine learning techniques may analyze visual and audio cues within the broadcast feed to detect replay segments, including changes in camera perspective, slow-motion effects, graphical overlays indicating replay content, and audio commentary patterns that typically accompany replay sequences. By automatically detecting these replay boundaries, the system may seamlessly integrate replay footage with the primary trigger event footage to create a comprehensive video clip that includes both the live action and subsequent replay perspectives. In some examples, highlight package creation may be based on one or more machine learning determined qualifiers (e.g., xG or momentum). For example, a package may be set to be between a set time range such as two to three minutes. The system may decide which generated clips to include based on priority (e.g., having higher xG scores associated with a clip). This determination may lead to a generated package having the most relevant clips included. The prioritization algorithm may consider multiple factors when selecting clips for inclusion in a package, including the significance of the trigger event, the quality of the video footage, the relevance to the target audience, and the overall narrative flow of the assembled package. In some examples, the system may automatically adjust the number of clips included in a package based on the target duration, selecting higher-priority clips when the available content exceeds the target duration or including additional context clips when the available high-priority content is insufficient to meet the minimum duration requirement. Exemplary packages may be displayed in Table 4 below. Table 4 below shows exemplary packages that may be selected by a user implementing method 500.

TABLE 4

| Package | | | |
|---|---|---|---|
| Type | Classification | Content Type | Release |
| Individual | — | Trigger events as described | During sporting |
| Clips | | above; | occasion |
| Match | long | Goal, yellow card, red card, | During sporting |
| Highlights | short | shot on goal, shot, big | occasion |
| | | chance, and manual | |
| | | clipping | |
| Exciting | long | Trigger events based on | After sporting |
| Moments | short | excitement data | occasion |
| Player | Combination | Good performance, bad | After sporting |
| focus | of player | performance. | occasion |
| | event and | | |
| | event type | | |
| By event | Combination | Best shots, duels lost | After sporting |
| type | of player | | occasion |
| | event and | | |
| | event type | | |

Additional exemplary packages may further be illustrated in Table 5 below. The package configurations shown in Table 5 demonstrate the flexibility of the system to generate specialized content packages based on various categorization criteria. Each package type may be configured to automatically generate multiple individual clips that are subsequently stitched together based on the specified event categories and filtering criteria. The system may apply intelligent ordering algorithms when stitching clips together, arranging the individual clips chronologically, by significance, or according to a narrative structure that best serves the intended purpose of the package.

TABLE 5

| Event Category | Description | Examples | Release |
|---|---|---|---|
| By match time | Events occurring within the | First half only events, | After sporting |
| | specific match time | last twenty minutes | occasion |
| Attacking events | Specific space on the pitch | Right wing, inside the | After sporting |
| by pitch | (defined by coordinates and | box | occasion |
| | markings) | | |
| Defensive events | Specific space on the pitch | Right wing, middle | After sporting |
| by pitch | (defined by coordinates and | third, last line | occasion |
| | markings) | | |
| By pass type | Based on type of touch taken by a | Headers, long balls | After sporting |
| | player from a team | | occasion |
| By event type | Based on statistical form of the | Goals, red cards, shot | After sporting |
| | event | on goal, fouls | occasion |
| By player/position | All trigger events of a player | Passes, fouls, goals | After sporting |
| | | | occasion |
| Pass direction | Based on ball coverage | Long, short, front | After sporting |
| | | | occasion |
| Pass outcome | Kept the ball or not | Successful passes | After sporting |
| | | | occasion |
| Smart rating | Over or under rating | All events above 70 | After sporting |
| score | | for a team | occasion |
| Smart rating | Pick the best or worst event | Top 10 events | After sporting |
| percentile | based on the ratings | | occasion |

Another example of automatically created packages is shown in Table 6 below. The package types illustrated in Table 6 demonstrate how multiple clips may be generated based on different event criteria and subsequently stitched together to create comprehensive analytical packages. For example, a ball retention package may include multiple clips showing instances where a specific player successfully retained possession, with each individual clip generated separately and then combined into a single cohesive video that illustrates the player's ball retention capabilities throughout the match. Similarly, a tactical switches package may compile multiple clips showing different tactical adjustments made during the match, with each clip capturing a specific tactical change and the combined package providing a comprehensive overview of the team's tactical evolution throughout the sporting occasion.

TABLE 6

| Package Type | Event 1 | Event 2 |
|---|---|---|
| Ball retention/giving away | By player/position | Pass outcome |
| Tactical switches | By touch | By player/position |
| Defensive lapses | Pass outcome | Pass type |

Further, a user may be able to select functions related to trigger events. Table 7 below may display potential rules that may be generated by a user during method 500. The functions and rules shown in Table 7 provide users with granular control over the video generation process, enabling customization of both individual clips and assembled packages. The rule configuration system may allow users to define comprehensive specifications that govern how multiple clips are generated and how those clips are subsequently stitched together into cohesive packages. For example, a user may configure rules that specify the trigger events to capture, the video format specifications to apply, the branding elements to include, and the ordering criteria for assembling multiple clips into a package. These rules may be saved and reused across multiple sporting occasions, enabling consistent and automated video generation without requiring manual configuration for each individual match or competition.

TABLE 7

| Function | Description | UI-Prescribed | When |
|---|---|---|---|
| Package/ | Pick either package | Toggle | During sporting |
| clip | or clip option from a | | occasion or Post |
| | user defined or pre- | | Sporting |
| | determined list | | occasion |
| competition | Pick 1 or more | Single or multi- | During or post |
| | (based on | select dropdown | sporting |
| | onboarding) (e.g., a | | occasion |
| | preselected | | |
| | competition | | |
| | associated with a | | |
| | user | | |
| Events | Event list based on | Multi options | During and post |
| (comes | prescribed event list, | check list. Can | sporting |
| within | which is based on | be edited | occasion |
| package) | selected package | | |
| Trigger for | Pick 1 or more | Multi-select | During and post |
| clipping | triggers from a list | dropdown. Can | sporting |
| | based on selected | be edited | occasion |
| | package | | |
| Resolution | Pick either 1 or | toggle, multi- | During or post |
| | multiple of 16:9, | select | sporting occasion |
| | 1:1, 9:16 | dropdown | |
| Pre-Roll | Add a video or | Error in case of | During sporting |
| | image file | criteria not met or | occasion |
| | | success | |
| Post-Roll | Add a video or | Error in case of | During sporting |
| | image file | criteria not met or | occasion |
| | | success | |
| Logo | Add an image | Error in case of | During sporting |
| | | criteria is not met | occasion |
| | | or success | |
| File | Pick 1 or multiple | Single select | During sporting |
| Resolution | from list | dropdown or | occasion |
| | | multi option | |
| | | checklist | |
| Preview | Play entire functions | Full screen video | During sporting |
| Viewer | based on the UI-led | player from | occasion |
| | items selected | simple video | |
| | | command | |
| | | (volume, play, | |
| | | pause) | |
| Rule Name | List of items | Text box | During sporting |
| | selected in above | | occasion |
| | functions | | |

In some examples, a user may preview video rules selected and potential outputs when determining what trigger events to record. The preview functionality may enable users to visualize how the configured rules will affect the generated video clips before committing to the configuration. The preview may display a sample video clip that demonstrates the application of the selected trigger events, video format specifications, branding elements, and other configured parameters. This preview capability may allow users to iteratively refine their rule configurations to achieve the desired output characteristics before the rules are applied to live sporting occasions. In some examples, the preview may demonstrate how multiple clips will be stitched together when a package configuration is selected, showing the transitions between clips, the ordering of content, and the overall flow of the assembled package. The preview functionality may also display estimated processing times and storage requirements based on the configured rules, enabling users to optimize their configurations for performance and resource utilization. In some examples, the system may provide recommendations or suggestions based on the user's configured rules, such as suggesting alternative aspect ratios for specific distribution platforms or recommending additional trigger events that may enhance the comprehensiveness of the generated content.

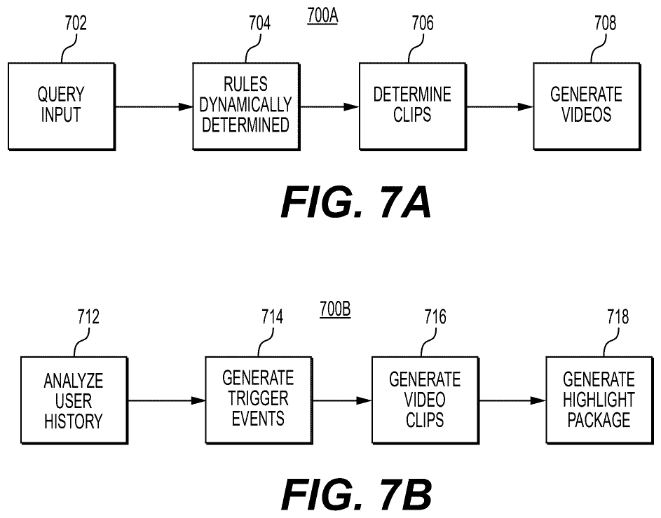

FIG. 7A is a flow diagram of an exemplary method 700A for generating video clips from a query, according to one or more embodiments. The method 700A may, for example, be implemented by video clipping environment 200 and/or computer environment 100. Method 700A may allow for user text query or an automated query (e.g., based on a user or system preference, a user or system profile, etc.) to be utilized to generate video clips through natural language processing and dynamic rule generation.

At step 702, a user or automated system (e.g., via the client systems 208 of FIG. 2) may provide a query of a requested type of video to generate. The query input may be received through one or more interfaces, including text input fields, voice recognition systems, or structured query forms. For example, a user may include a search such as “I want to see Steph Curry 3-pointers,” “Show me all goals by Messi in the 2022 World Cup,” or “Generate highlights of defensive plays by the Lakers in the fourth quarter.” The query may include specific player names, team names, event types, time periods, statistical thresholds, or combinations thereof. The system may be configured to parse complex queries that include multiple criteria, such as “Show me all corner kick goals by Manchester United in the Premier League this season where the ball was crossed from the right side.” The query processing may also support temporal references such as “last week,” “this season,” or specific date ranges.

At step 704, a machine learning model (e.g., a large language model) may dynamically create trigger events, qualifiers, and associated rules of relevant aspects of the query, in accordance with the techniques disclosed herein. This step 704 involves sophisticated natural language processing to extract meaningful parameters from the user query. The machine learning model may first parse the query to identify key entities such as player names, team names, event types, and contextual modifiers. The system may then identify relevant sporting occasions related to the query by accessing historical sporting occasion data, player statistics, and event databases. Next, potential trigger events may be identified based on the parsed query elements (e.g., three-point shots by a specific player, goals scored during specific sporting occasion situations, defensive actions in particular time periods). The machine learning model may also determine appropriate qualifiers that further refine the trigger events, such as shot location, assist type, sporting occasion context, or performance metrics. Last, qualifiers and associated rules may be created in accordance with the techniques disclosed herein, including determining optimal clipping parameters, video duration, and contextual elements to include. The machine learning model may leverage sports-specific knowledge to understand nuanced queries, such as distinguishing between different types of shots, understanding positional play, or recognizing tactical situations. The dynamic rule generation may also consider user preferences, viewing history, and platform-specific requirements to optimize the generated content.

At step 706, video clips responsive to the user query may be determined through multiple pathways. For example, this may include either (1) applying the clipping module 124 to generate a video clip based on the dynamically determined rules from step 704 for relevant broadcast feeds; (2) searching the video repository 228 for previously generated clips related to the user query from step 702; and/or identifying events within a broadcast video stream without reliance on a rule. The determination process may involve ranking and scoring potential clips based on relevance to the query, recency of the content, video quality, and user preferences. If generating new clips, the system may access live or archived broadcast feeds and apply the dynamically created trigger events and qualifiers to identify relevant moments. The system may also combine multiple approaches, such as retrieving existing clips that partially match the query and generating additional clips to complete the requested content. Advanced matching algorithms may be employed to identify clips that satisfy complex query criteria, including semantic matching that goes beyond exact keyword matching. The system may also consider metadata associated with existing clips, such as player performance metrics, sporting occasion context, and previously assigned tags or classifications.

At step 708, the determined clips may be generated (e.g., either retrieved or created) and output to the user from step 702. This comprehensive output generation process may include combining multiple relevant clips and assembling them into a single cohesive video format with appropriate transitions and sequencing. The system may apply intelligent ordering algorithms to arrange clips chronologically, by importance, or according to narrative flow that best serves the user's intent. These video clips may further include overlays and/or commentary based on the user query, such as statistical information, player performance metrics, contextual sporting occasion information, or AI-generated insights relevant to the specific query. The output may be customized according to user preferences for video format, resolution, aspect ratio, and duration. Advanced post-processing may include automatic highlight detection within the generated clips, dynamic cropping to focus on key players or actions, and the addition of graphical elements such as player tracking lines, statistical overlays, or tactical analysis visualizations. The system may also generate accompanying metadata, descriptions, or summaries that provide context for the generated video content. Quality assurance mechanisms may be implemented to ensure the generated clips accurately respond to the user query and meet technical standards for video quality and content relevance.

FIG. 7B is a flow diagram of an exemplary method 700B for generating a video highlight package based on user history, according to one or more embodiments. The method 700B may, for example, be implemented by the video clipping environment 200 of FIG. 2 and/or computer environment 100 of FIG. 1. Method 700B may allow for customized (e.g., personalized) video content generation by analyzing user behavior patterns and preferences to automatically create customized highlight packages.

At step 712, the system may analyze user history data to identify viewing patterns and content preferences. The user history data may include information about previously viewed video clips, search queries, interaction metrics such as watch time and engagement rates, and user-generated content selections. The system may track which types of trigger events a user frequently views, which players or teams the user follows, preferred video durations, and temporal viewing patterns. The analysis may also consider metadata associated with previously created or viewed clips, including event types, sporting occasion contexts, player performances, and statistical thresholds. The system may implement machine learning models to identify correlations and patterns within the user history data, such as determining that a user consistently views defensive plays, prefers clips featuring specific players, or engages more with content from particular competitions or time periods. The analysis may further incorporate user feedback mechanisms, such as ratings, likes, or explicit preferences indicated through user interface selections. The system may also analyze the frequency and recency of user interactions to weight more recent preferences more heavily in the analysis.

At step 714, the system may generate trigger events based on the analyzed user history from step 712. The trigger events may be dynamically determined to align with the identified user preferences and viewing patterns. For example, if the user history indicates a preference for viewing goals scored by a particular player, the system may generate trigger events corresponding to goals by that player. If the analysis reveals interest in specific event types such as defensive interceptions or fast break plays, the system may create trigger events for those action types. The system may also generate trigger events based on statistical thresholds that align with user preferences, such as creating trigger events for plays with high expected goal values if the user frequently engages with high-quality scoring opportunities. The trigger event generation may consider temporal factors, such as prioritizing recent sporting occasions or upcoming matches involving teams or players of interest to the user. The system may also generate trigger events based on combinations of preferences, such as identifying corner kick goals by a favorite team during critical match moments. The dynamic trigger event generation may be performed by a machine learning model trained to map user preference patterns to relevant sporting occasion actions.

At step 716, the system may generate video clips corresponding to the trigger events identified in step 714. The video clip generation may apply the techniques described in method 300 of FIG. 3, including determining qualifiers associated with each trigger event and establishing appropriate clipping parameters. The system may access broadcast data, event data, and tracking data to create video clips that capture the relevant trigger events with appropriate context. The video clips may be generated with specifications that align with user preferences identified in the history analysis, such as preferred aspect ratios, video durations, or inclusion of specific graphical overlays. The system may also apply user-preferred video enhancement features, such as adding statistical overlays, player tracking visualizations, or tactical analysis graphics based on the user's historical engagement with such features. The video clip generation may prioritize content quality and relevance based on the user's viewing patterns, ensuring that the generated clips match the user's demonstrated preferences for video presentation and content focus.

At step 718, the system may generate a highlight package by combining the video clips created in step 716. The highlight package may be assembled according to user preferences for package structure, duration, and content organization. The system may apply intelligent sequencing algorithms to arrange the clips in an order that maximizes engagement based on the user's historical viewing patterns, such as arranging clips chronologically, by importance, or by thematic groupings that align with user interests. The highlight package may include transitions, introductions, or summaries that provide context for the compiled content. The system may also apply user-preferred branding elements, such as logos, pre-roll or post-roll content, or custom graphics that the user has previously selected or engaged with. The package generation may consider optimal duration based on the user's typical viewing session lengths and may prioritize the most relevant clips if the available content exceeds the target duration. The system may also generate multiple versions of the highlight package with different durations or content selections to provide the user with options that match different viewing contexts or time constraints. The generated highlight package may be automatically delivered to the user through preferred distribution channels identified in the user history, such as specific client applications, social media platforms, or email notifications.

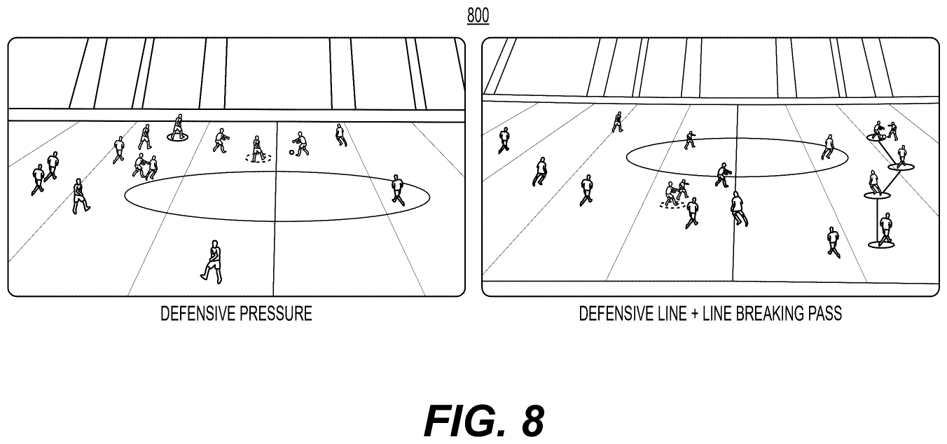

FIG. 8 is a snapshot 800 of a generated video clip, according to one or more embodiments. For example, FIG. 8 depicts an exemplary normal snapshot of a video clip (shown on the left) alongside a video clip snapshot that includes AI insight (to the right). The overlay may for example have been implemented by the clipping module 124 of FIG. 1 and FIG. 2 and may provide additional context and information for a video. In this example, a line may trace a line of the defensive players (e.g., a defensive formation).

The techniques described herein may further be utilized to create historical clips to show context for a player. Such creation of historical clips may include generating video clips of all trigger events for a particular player in a sporting occasion or season and combining these into a single video. The system may be configured to add an avatar or computer-generated player to replace actual players in a video clip. The system may further be configured to generate video clips highlighting around a player or object (e.g., the ball). For example, a ring may denote a relevant player or object in a particular video clip.

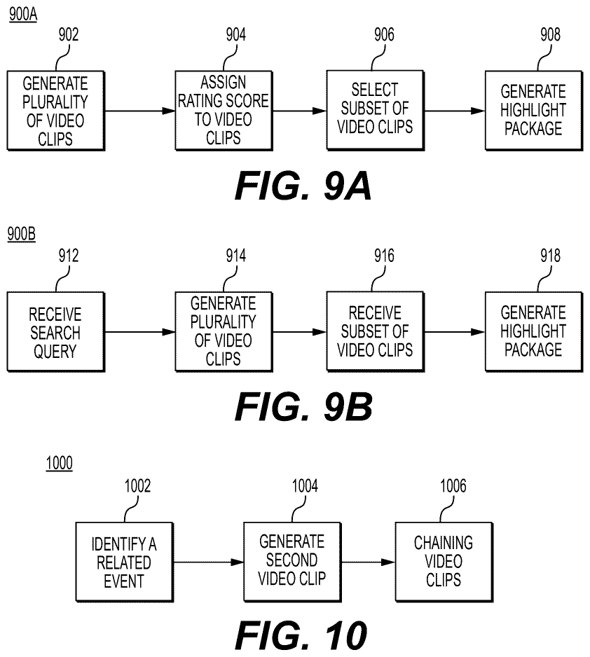

FIG. 9A is a flow diagram of an exemplary method 900A for generating a highlight package, according to one or more embodiments. The method 900A may, for example, be implemented by the video clipping environment 200 of FIG. 2 and/or computer environment 100 of FIG. 1. Method 900 may allow for automated curation and assembly of video content based on rating scores assigned to individual clips.

At step 902, the system may generate a plurality of video clips for a plurality of trigger events occurring during the sporting occasion. The video clip generation may apply the techniques described in the method 300 of FIG. 3, including receiving event data objects, determining trigger events, identifying qualifiers, and generating video clips based on clipping parameters. The plurality of video clips may correspond to various trigger events that occurred throughout a single sporting occasion or across multiple sporting occasions within a defined time period or competition.

At step 904, the system may assign a rating score to each video clip of the plurality of video clips. The rating score may be determined based on characteristics of the corresponding trigger event and may rate each trigger event relative to other events of the same type. For example, goals may be rated relative to other goals based on factors such as expected goal (xG) values, the significance of the goal within the match context, the quality of the play leading to the goal, or the difficulty of the shot. The rating score may also consider factors such as player involvement, sporting occasion state at the time of the trigger event, crowd excitement levels, or commentary intensity. In some aspects, the rating score may be generated by a machine learning model trained to evaluate the significance and quality of sporting occasion actions. The rating score may be a numerical value, a percentile ranking, or a categorical classification that enables comparison and selection among the plurality of video clips.

At step 906, the system may select a subset of the plurality of video clips based on the assigned rating scores. The selection process may involve identifying clips with rating scores that exceed a threshold value, selecting a predetermined number of top-rated clips, or selecting clips that fall within a target percentile range. The selection may also consider constraints such as target highlight package duration, ensuring that the selected subset of clips may be combined into a package that meets duration requirements. In some cases, the selection may balance rating scores with diversity considerations, such as ensuring representation of different event types, different players, or different time periods within the sporting occasion.

At step 908, the system may generate a highlight package by combining the subset of the plurality of video clips selected in step 906. The highlight package may be assembled with appropriate transitions between clips, consistent formatting, and cohesive presentation. The system may apply sequencing algorithms to arrange the selected clips in an order that maximizes viewer engagement, such as chronological order, order of significance based on rating scores, or narrative order that builds toward the most highly rated moments. The highlight package may include introductory elements, summary graphics, or concluding segments that provide context for the compiled content.

FIG. 9B is a flow diagram of an exemplary method 900B for generating a highlight package based on user selections, according to one or more embodiments. The method 900B may, for example, be implemented by the video clipping environment 200 of FIG. 2 and/or computer environment 100 of FIG. 1. Method 900B may allow for a user to assemble video clips to generate a highlight package.

At step 912, the system may receive a search query input from a user through a user interface. The user interface may display a flexible search capability that enables the user to query and discover content across a broad range of data points and sporting events. The search query may include one or more search filters that allow the user to specify criteria for identifying relevant video content. The search filters may include competition filters for selecting specific leagues or tournaments, team filters for identifying content associated with particular teams, player filters for locating content featuring specific athletes, match filters for selecting content from particular games, venue filters for identifying content from specific stadiums or arenas, manager filters for locating content associated with particular coaches or managers, and match event filters for selecting content based on specific sporting occasions or event types. The user may apply one or more of these filters in combination to refine the search results. The search capability may leverage synchronized game footage and associated data, where the entirety of the game footage has been synchronized with the entirety of the data for that game. This synchronization may enable searching across metadata associated with the video content, allowing users to discover content that may not have been previously identified through trigger event detection.

At step 914, the system may generate a plurality of video clips based on the search query received at step 912. The system may access the synchronized game footage and associated metadata to identify video segments that match the search criteria specified by the user. The video clip generation may apply techniques similar to those described in method 300, including determining appropriate clipping parameters and generating video clips with specified formatting and presentation characteristics. The generated plurality of video clips may be transmitted to the user interface for display to the user. The user interface may present the search results as a collection of video clips that the user may browse, preview, and evaluate for inclusion in a highlight package.

At step 916, the system may receive a subset of video clips selected by the user from the plurality of video clips generated at step 914. The user interface may provide interactive elements that enable the user to review the generated video clips and select which clips should be included in the highlight package. The user may browse through the output videos displayed in the user interface and select individual clips for inclusion. The user interface may further enable the user to arrange the selected clips in a particular order by dragging the clips to desired positions within a sequence. This user-driven workflow may allow the user to curate the content and structure of the highlight package according to the user's preferences and objectives.

At step 918, the system may generate a highlight package by combining the subset of video clips received at step 916. The highlight package may be assembled according to the order specified by the user through the drag-and-drop arrangement performed in the user interface. The system may apply transitions between the selected clips, consistent formatting, and cohesive presentation elements to create a polished highlight package. The generated highlight package may incorporate user-specified settings such as aspect ratio, resolution, branding elements, and pre-roll or post-roll content.

The method 900B may provide a user-driven approach to highlight package generation that differs from automated trigger-based approaches. By synchronizing game footage with comprehensive game data, the method 900B may enable users to search across a greater number of data points and games than would be available through trigger-based clip generation alone. The search-based approach may allow users to discover and include content based on metadata attributes that may not correspond to predefined trigger events, providing flexibility in content curation and highlight package assembly.

FIG. 10 is a flow diagram of an exemplary method 1000 for generating a chained video clip, according to one or more embodiments. The method 1000 may, for example, be implemented by the video clipping environment 200 of FIG. 2 and/or computer environment 100 of FIG. 1. Method 1000 may allow for automatic assembly of related video segments into a combined video clip without requiring intermediate processing steps.

At step 1002, the system may identify a related event associated with a trigger event. The related event may include one or more of: a replay of the trigger event from a different camera perspective, a video review decision related to the trigger event, or a subsequent action following the trigger event. For example, if the trigger event is a goal, the related event may include a replay showing the goal from an alternative camera angle, a video assistant referee (VAR) review of the goal, or a celebration sequence following the goal. The identification of related events may be performed by analyzing event data objects to detect temporal or contextual relationships between events, or by implementing pattern recognition to identify replay segments within the broadcast feed.

At step 1004, the system may generate a second video clip of the related event. The second video clip generation may apply similar techniques to those used for generating the primary video clip of the trigger event, including determining appropriate clipping parameters based on the type of related event. For replay segments, the system may implement machine learning techniques to automatically detect when the replay starts and ends within the broadcast feed by analyzing visual cues such as slow-motion effects, graphical overlays, or camera perspective changes.

At step 1006, the system may chain together the video clip of the trigger event and the second video clip of the related event to create a combined video clip. The chaining process may apply transition effects between the segments, normalize audio levels across the combined content, and ensure visual consistency throughout the assembled clip. The combined video clip may be automatically generated without creating intermediate raw clips, enabling efficient processing and rapid delivery of comprehensive video content that captures both the primary action and associated related events.

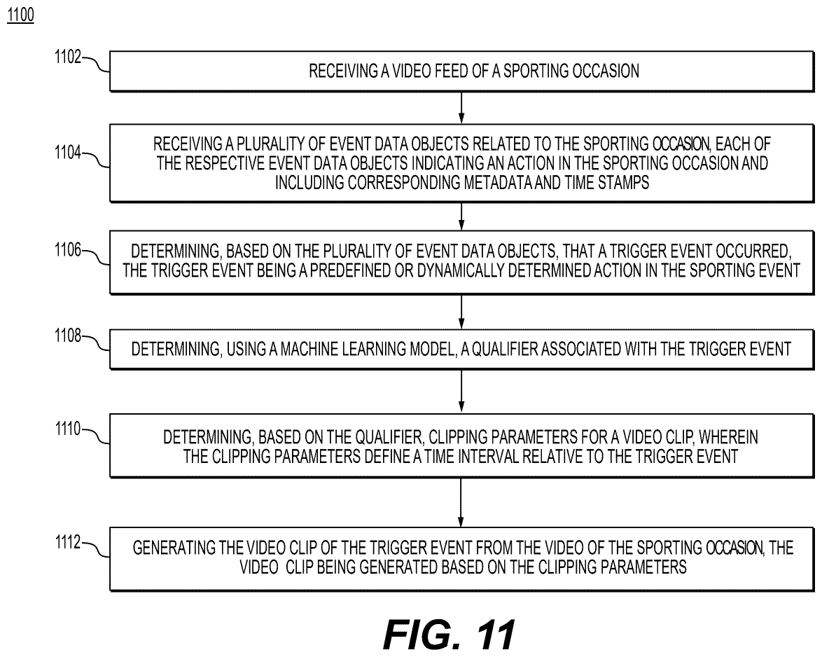

FIG. 11 depicts a flow diagram of a method 1100 for generating video clips of a sporting occasion by implementing a machine learning model, according to one or more embodiments. The method 1100 may, for example, be implemented by video clipping environment 200 and/or computer environment 100. Method 1100 may allow for automated video clip generation based on trigger events and associated qualifiers.

Step 1102 may include receiving a video feed of a sporting occasion. The video feed may be received in various formats and resolutions, including high-definition (HD), ultra-high-definition (UHD), or standard-definition formats, and may include multiple camera angles or perspectives of the sporting occasion. The video feed may further include associated audio data, such as commentary, crowd noise, referee calls, and ambient sound captured during the sporting occasion.

Step 1104 may include receiving a plurality of event data objects related to the sporting occasion, each of the =event data objects indicating an action in the sporting occasion and including corresponding metadata and timestamps. Step 1104 may include receiving event data objects where the plurality of event data objects includes pre-defined or automatically generated actions that occur during the sporting occasion. Step 1104 may further include receiving event data objects wherein the metadata for each respective event data object includes classification metrics defining the respective event data object and players associated with the respective event data object.

Step 1106 may include determining, based on the plurality of event data objects, that a trigger event occurred, the trigger event being a predefined or dynamically determined action in the sporting occasion.

Step 1108 may include determining, using a machine learning model, a qualifier associated with the trigger event. Step 1108 may include processing, using the machine learning model, a portion of the plurality of event data objects with timestamps prior to the trigger event and identifying a pattern of play leading to the trigger event, wherein the pattern of play includes a sequence of actions performed by one or more players.

Step 1110 may include determining based on the qualifier, clipping parameters for the video clip, wherein the clipping parameters define a time interval relative to the trigger event. Step 1110 may include accessing a lookup table or database that associates the determined qualifier with corresponding clipping rules. Step 1110 may further include retrieving, from the lookup table or database, a time interval associated with the determined qualifier, wherein the time interval defines a duration prior to the trigger event to be included in the video clip. Step 1110 may further include determining a start point for the video clip based on the time interval and a timestamp of the trigger event. Step 1110 may further include generating a refined start point using a second machine learning model configured to identify one or more of: an audio break point in audio associated with the video feed, or a scene cut in the video feed, wherein the refined start point corresponds to a natural break point proximate to the start point.

Step 1112 may include generating a video clip of the trigger event from the video feed of the sporting occasion, the video clip being generated based on the clipping parameters. Step 1112 may include generating the video clip wherein the video clip includes video clip metadata, the video clip metadata including a player associated with the trigger event, a team associated with the trigger event, a date associated with the sporting occasion, and/or a timestamp associated with the trigger event. Step 1112 may include generating the video clip by a second machine learning model, the second machine learning model being configured to fuse multiple views of the trigger event into the video clip.

The method 1100 may further include overlaying graphical content on the video clip, wherein the graphical content includes one or more of augmented graphics displaying player positioning information, statistical data associated with the trigger event, expected goal (xG) values, expected pass values, expected threat values, distance measurements between players, or data-driven visual elements.

The method 1100 may further include receiving tracking data of the sporting occasion from a tracking system; determining, based on the tracking data, a cropping format for the video clip; and automatically cropping the video clip to the determined cropping format by identifying a location of an object or player in the video feed based on the tracking data and dynamically adjusting a display area to follow the object or player.

The method 1100 may further include generating a plurality of additional video clips for a plurality of additional trigger events occurring during the sporting occasion; assigning a rating score to each additional video clip of the plurality of additional video clips, wherein the rating score is determined based on characteristics of the corresponding trigger event from the plurality of additional trigger events, and rates each additional trigger event relative to other additional trigger events of a same type; selecting a subset of the plurality of additional video clips based on the assigned rating scores; and generating a highlight package by combining the subset of the plurality of additional video clips and the video clip.

The method 1100 may further include identifying a related event associated with the trigger event, wherein the related event includes one or more of: a replay of the trigger event from a different camera perspective, a video review decision related to the trigger event, or a subsequent action following the trigger event; generating a second video clip of the related event; and chaining together the video clip of the trigger event and the second video clip of the related event to create a combined video clip, wherein the combined video clip is automatically generated without creating an intermediate raw clip.

The system described herein may implement various machine learning models across multiple components and processes. For example, the end-to-end system (e.g., the video clipping environment 200 of FIG. 2) may orchestrate the flow using individual components which leverage one or more machine learning models. Machine learning models may be utilized for tracking data generation from broadcast video feeds using artificial intelligence and computer vision systems to derive player-tracking data, map pixels corresponding to players and objects, and perform skeleton tracking for player detection and re-identification. Machine learning models may generate qualifiers (e.g., xG) and be implemented to generate or update qualifiers by analyzing event data patterns and determining contextual information about trigger events. Machine learning models may sync data and/or content (e.g., video) streams (e.g., using multimodal LLM and/or vision language models), refine rules for clipping (e.g., using audio, audio transcription, and/or scene detection as inputs for ML and/or LLM models), and create highlight packages (e.g., choosing which trigger events to include, determining highlight length, etc.) using metadata, machine learning metrics, or the like as selection features (e.g., output by an LLM). Machine learning models may be employed for automatic event detection using neural network systems trained to detect shots, scores, points, rebounds, passes, dribbles, penalties, fouls, and possessions, as well as specialist event detectors for higher-level events such as plays, transitions, presses, crosses, breakaways, and ball-screens. Machine learning models may generate contextual information including defensive matchup information and coverage analysis. Machine learning models may be used for video clip generation by fusing multiple views of trigger events, implementing dynamic framing adjustments, automatic camera angle selection, and seamless transitions between different perspectives. Machine learning models may process natural language queries to dynamically create trigger events, qualifiers, and associated rules, enabling query-based video generation. Machine learning models may analyze user history data to identify viewing patterns and content preferences for generating customized highlight packages. Machine learning models may determine optimal clipping parameters, video cropping formats, and overlay placement for AI-generated insights and statistical data visualization.

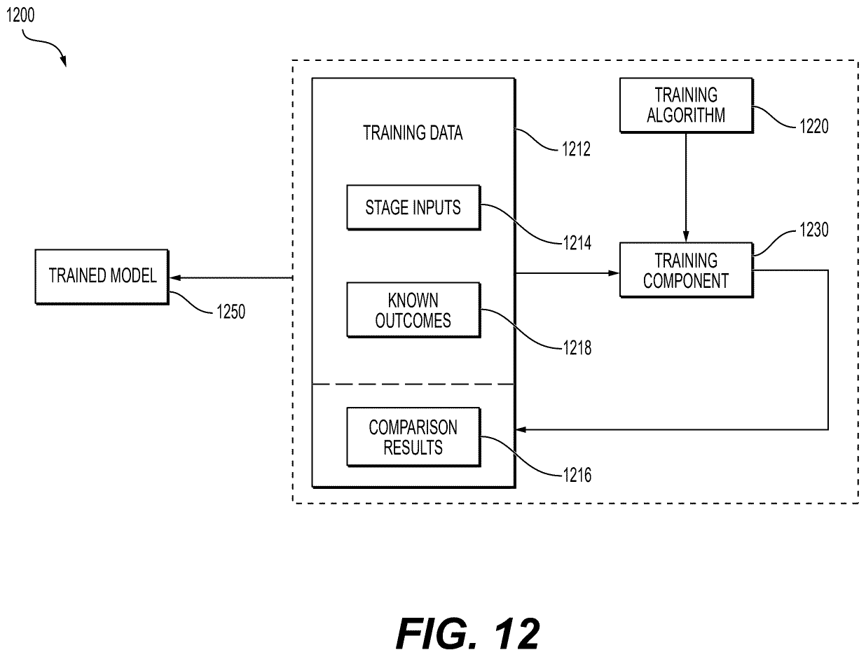

FIG. 12 depicts a flow diagram for training a machine learning model, in accordance with an aspect of the disclosed subject matter. As shown in a flow diagram 1200 of FIG. 12, training data 1212 may include one or more of stage inputs 1214 or known outcomes 1218 related to a machine learning model to be trained. The stage inputs 1214 may be from any applicable source including a component or set shown in the figures provided herein. The known outcomes 1218 may be included for machine learning models generated based on supervised or semi-supervised training. An unsupervised machine learning model might not be trained using the known outcomes 1218. The known outcomes 1218 may include known or desired outputs for future inputs similar to or in the same category as the stage inputs 1214 that do not have corresponding known outputs.

The training data 1212 and a training algorithm 1220 may be provided to a training component 1230 that may apply the training data 1212 to the training algorithm 1220 to generate a trained machine learning model 1250. According to an implementation, the training component 1230 may be provided comparison results 1216 that compare a previous output of the corresponding machine learning model to apply the previous result to re-train the machine learning model. The comparison results 1216 may be used by the training component 1230 to update the corresponding machine learning model. The training algorithm 1220 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 1200 may be the trained machine learning model 1250.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score statistic may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting occasions with corresponding time boundaries, teams, players, coaches, officials, and environmental data associated with a location of corresponding sporting occasions.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

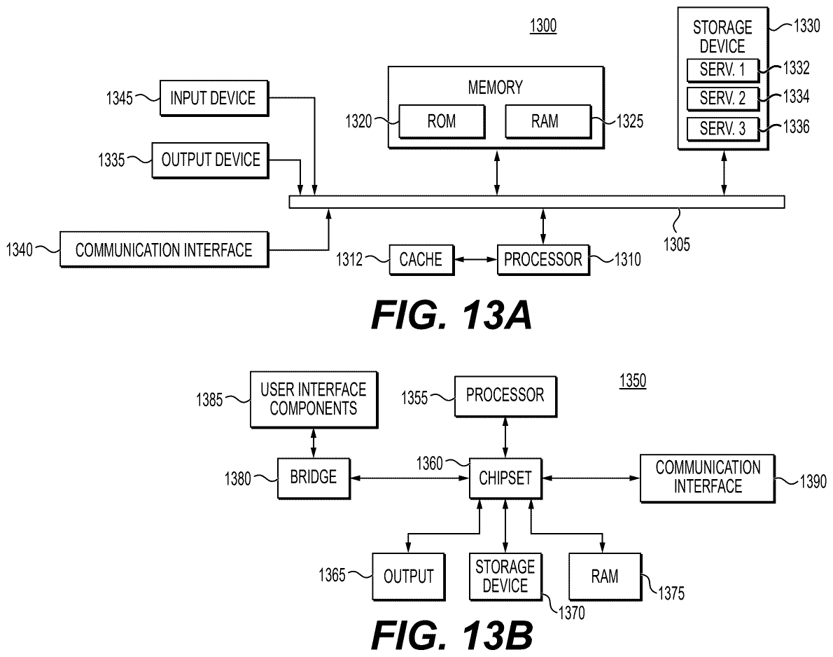

FIG. 13A illustrates an architecture of a computing system 1300, according to example embodiments. The computing system 1300 may be representative of at least a portion of the organization computing system 104. One or more components of the computing system 1300 may be in electrical communication with each other using a bus 1305. The computing system 1300 may include a processing unit (CPU or processor) 1310 and a system bus 1305 that couples various system components including a system memory 1315, such as read only memory (ROM) 1320 and random access memory (RAM) 1325, to the processor 1310. The computing system 1300 may include a cache of high-speed memory connected directly with, in close proximity to, or integrated as part of the processor 1310. The computing system 1300 may copy data from the system memory 1315 and/or a storage device 1330 to a cache 1312 for quick access by the processor 1310. In this way, the cache 1312 may provide a performance boost that avoids processor 1310 delays while waiting for data. These and other modules may control or be configured to control the processor 1310 to perform various actions. Other system memory 1315 may be available for use as well. The system memory 1315 may include multiple different types of memory with different performance characteristics. The processor 1310 may include any general purpose processor and a hardware module or software module, such as service 1 1332, service 2 1334, and service 3 1336 stored in the storage device 1330, configured to control the processor 1310 as well as a special-purpose processor where software instructions are incorporated into the actual processor design. The processor 1310 may essentially be a completely self-contained computing system, containing multiple cores or processors, a bus, memory controller, cache, etc. A multi-core processor may be symmetric or asymmetric.

To enable user interaction with the computing system 1300, an input device 1345 may represent any number of input mechanisms, such as a microphone for speech, a touch-sensitive screen for gesture or graphical input, keyboard, mouse, motion input, speech and so forth. An output device 1335 (e.g., display) may also be one or more of a number of output mechanisms known to those of skill in the art. In some instances, multimodal systems may enable a user to provide multiple types of input to communicate with the computing system 1300. A communications interface 1340 may generally govern and manage the user input and system output. There is no restriction on operating on any particular hardware arrangement and therefore the basic features here may easily be substituted for improved hardware or firmware arrangements as they are developed.

The storage device 1330 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1325, read only memory (ROM) 1320, and hybrids thereof.

The storage device 1330 may include the services 1332, 1334, and 1336 for controlling the processor 1310. Other hardware or software modules are contemplated. The storage device 1330 may be connected to the system bus 1305. In one aspect, a hardware module that performs a particular function may include the software component stored in a computer-readable medium in connection with the necessary hardware components, such as the processor 1310, the bus 1305, the output device 1335, and so forth, to carry out the function.

FIG. 13B illustrates a computer system 1350 having a chipset architecture that may represent at least a portion of the organization computing system 104. The computer system 1350 may be an example of computer hardware, software, and firmware that may be used to implement the disclosed technology. The computer system 1350 may include a processor 1355, representative of any number of physically and/or logically distinct resources capable of executing software, firmware, and hardware configured to perform identified computations. The processor 1355 may communicate with a chipset 1360 that may control input to and output from the processor 1355. In this example, the chipset 1360 outputs information to an output 1365, such as a display, and may read and write information to a storage device 1370, which may include magnetic media, and solid-state media, for example. The Chipset 1360 may also read data from and write data to a RAM 1375. A bridge 1380 for interfacing with a variety of user interface components 1385 may be provided for interfacing with the chipset 1360. Such user interface components 1385 may include a keyboard, a microphone, touch detection and processing circuitry, a pointing device, such as a mouse, and so on. In general, inputs to the computer system 1350 may come from any of a variety of sources, machine generated and/or human generated.

The Chipset 1360 may also interface with one or more communication interfaces 1390 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by the processor 1355 analyzing data stored in the storage device 1370 or the RAM 1375. Further, the machine may receive inputs from a user through the user interface components 1385 and execute appropriate functions, such as browsing functions by interpreting these inputs using the processor 1355.

It may be appreciated that example systems 1300 and 1350 may have more than one processor 1310 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed:

1. A method for generating video clips of a sporting occasion by implementing a machine learning model, the method comprising:
receiving a video feed of a sporting occasion;
receiving a plurality of event data objects related to the sporting occasion, each of the event data objects indicating an action in the sporting occasion and including corresponding metadata and timestamps;
determining, based on the plurality of event data objects, that a trigger event occurred, the trigger event being a predefined or dynamically determined action in the sporting occasion;
determining, using a machine learning model, a qualifier associated with the trigger event;
determining, based on the qualifier, clipping parameters for a video clip, wherein the clipping parameters define a time interval relative to the trigger event; and
generating the video clip of the trigger event from the video feed of the sporting occasion, the video clip being generated based on the clipping parameters.

2. The method of claim 1, further comprising:
overlaying graphical content on the video clip, wherein the graphical content includes one or more of augmented graphics displaying player positioning information, statistical data associated with the trigger event, expected goal (xG) values, expected pass values, expected threat values, distance measurements between players, or data-driven visual elements.

3. The method of claim 1, further comprising:
receiving tracking data of the sporting occasion from a tracking system;
determining, based on the tracking data, a cropping format for the video clip; and
automatically cropping the video clip to the determined cropping format by identifying a location of an object or player in the video feed based on the tracking data and dynamically adjusting a display area to follow the object or player.

4. The method of claim 1, further comprising:
identifying a related event associated with the trigger event, wherein the related event includes one or more of: a replay of the trigger event from a different camera perspective, a video review decision related to the trigger event, or a subsequent action following the trigger event;
generating a second video clip of the related event; and
chaining together the video clip of the trigger event and the second video clip of the related event to create a combined video clip,
wherein the combined video clip is automatically generated without creating an intermediate raw clip.

5. The method of claim 1, wherein the plurality of event data objects include pre-defined or automatically generated actions that occur during the sporting occasion.

6. The method of claim 1, wherein the metadata for each respective event data object includes:
classification metrics defining the respective event data object, and
players associated with the respective event data object.

7. The method of claim 1, wherein determining the qualifier includes:
processing, using the machine learning model, a portion of the plurality of event data objects with timestamps prior to the trigger event, and
identifying a pattern of play leading to the trigger event, wherein the pattern of play includes a sequence of actions performed by one or more players.

8. The method of claim 1, wherein the video clip includes video clip metadata, the video clip metadata includes one or more of a player associated with the trigger event, a team associated with the trigger event, a date associated with the sporting occasion, or a timestamp associated with the trigger event.

9. The method of claim 1, wherein the video clip is generated by a second machine learning model, the second machine learning model being configured to fuse multiple views of the trigger event into the video clip.

10. The method of claim 1, wherein determining the clipping parameters includes:
accessing a lookup table or database that associates the determined qualifier with corresponding clipping rules;
retrieving, from the lookup table or database, a time interval associated with the determined qualifier, wherein the time interval defines a duration prior to the trigger event to be included in the video clip;
determining a start point for the video clip based on the time interval and a timestamp of the trigger event; and
generating a refined start point using a second machine learning model configured to identify one or more of: an audio break point in audio associated with the video feed, or a scene cut in the video feed, wherein the refined start point corresponds to a natural break point proximate to the start point.

11. A system for generating video clips of a sporting occasion by implementing a machine learning model, the system comprising:
a non-transitory computer readable medium configured to store processor-readable instructions; and
a processor operatively connected to the non-transitory computer readable medium, and configured to execute the instructions to perform operations comprising:
receiving a video feed of a sporting occasion;
receiving a plurality of event data objects related to the sporting occasion, each of the event data objects indicating an action in the sporting occasion and including corresponding metadata and timestamps;
determining, based on the plurality of event data objects, that a trigger event occurred, the trigger event being a predefined or dynamically determined action in the sporting occasion;
determining, using a machine learning model, a qualifier associated with the trigger event;
determining, based on the qualifier, clipping parameters for a video clip, wherein the clipping parameters define a time interval relative to the trigger event; and
generating the video clip of the trigger event from the video feed of the sporting occasion, the video clip being generated based on the clipping parameters.

12. The system of claim 11, wherein the operations further comprise:
overlaying graphical content on the video clip, wherein the graphical content includes one or more of augmented graphics displaying player positioning information, statistical data associated with the trigger event, expected goal (xG) values, expected pass values, expected threat values, distance measurements between players, or data-driven visual elements.

13. The system of claim 11, wherein the operations further comprise:
receiving tracking data of the sporting occasion from a tracking system;
determining, based on the tracking data, a cropping format for the video clip; and
automatically cropping the video clip to the determined cropping format by identifying a location of an object or player in the video feed based on the tracking data and dynamically adjusting a display area to follow the object or player.

14. The system of claim 11, wherein the operations further comprise:
identifying a related event associated with the trigger event, wherein the related event includes one or more of: a replay of the trigger event from a different camera perspective, a video review decision related to the trigger event, or a subsequent action following the trigger event;
generating a second video clip of the related event; and
chaining together the video clip of the trigger event and the second video clip of the related event to create a combined video clip,
wherein the combined video clip is automatically generated without creating an intermediate raw clip.

15. A non-transitory computer readable medium storing processor-readable instructions which, when executed by at least one processor, cause the at least one processor to perform operations including:
receiving a video feed of a sporting occasion;
receiving a plurality of event data objects related to the sporting occasion, each of the event data objects indicating an action in the sporting occasion and including corresponding metadata and timestamps;
determining, based on the plurality of event data objects, that a trigger event occurred, the trigger event being a predefined or dynamically determined action in the sporting occasion;
determining, using a machine learning model, a qualifier associated with the trigger event;
determining, based on the qualifier, clipping parameters for a video clip, wherein the clipping parameters define a time interval relative to the trigger event; and
generating the video clip of the trigger event from the video feed of the sporting occasion, the video clip being generated based on the clipping parameters.

16. The non-transitory computer readable medium of claim 15, wherein the operations further include:
overlaying graphical content on the video clip, wherein the graphical content includes one or more of augmented graphics displaying player positioning information, statistical data associated with the trigger event, expected goal (xG) values, expected pass values, expected threat values, distance measurements between players, or data-driven visual elements.

17. The non-transitory computer readable medium of claim 15, wherein the operations further include:
receiving tracking data of the sporting occasion from a tracking system;
determining, based on the tracking data, a cropping format for the video clip; and
automatically cropping the video clip to the determined cropping format by identifying a location of an object or player in the video feed based on the tracking data and dynamically adjusting a display area to follow the object or player.

18. The non-transitory computer readable medium of claim 15, wherein the operations further include:
generating a plurality of additional video clips for a plurality of additional trigger events occurring during the sporting occasion;
assigning a rating score to each additional video clip of the plurality of additional video clips, wherein the rating score is determined based on characteristics of a corresponding trigger event from the plurality of additional trigger events, and wherein the rating score rates each additional trigger event relative to other additional trigger events of a same type;
selecting a subset of the plurality of additional video clips based on the assigned rating scores; and
generating a highlight package by combining the subset of the plurality of additional video clips and the video clip.
